(19) United States
(12) Patent Application Publication
(10) Pub. No.: US 2026/0034455 A1
(43) Pub. Date: Feb. 5, 2026

(54) EQUIPPING OF VIRTUAL ACCESSORY

(71) Applicant: Tencent Technology (Shenzhen) Company Limited, Shenzhen (CN)

(72) Inventor: Ziyi WANG, Shenzhen (CN)

(73) Assignee: Tencent Technology (Shenzhen) Company Limited, Shenzhen (CN)

(21) Appl. No.: 19/349,873

(22) Filed: Oct. 3, 2025

Related U.S. Application Data
(63) Continuation of application No. PCT/CN2024/118053, filed on Sep. 10, 2024.

(30) Foreign Application Priority Data
Nov. 30, 2023 (CN) 202311640567.0

(51) Int. Cl. A63F 13/58; A63F 13/537

(52) U.S. Cl. CPC A63F 13/58; A63F 13/537

(57) ABSTRACT

In a virtual accessory equipping method, a virtual scene including a virtual character and one or more virtual accessories is output for display. A configuration preview area with the virtual scene is output for display when the virtual character carries at least one virtual weapon. The configuration preview area includes a first preview of a first virtual weapon of the at least one virtual weapon. The first preview indicates a quantity of virtual accessories equipped on the first virtual weapon. Based on an equipping operation on a virtual accessory, the virtual accessory is equipped on the first virtual weapon carried by the virtual character. The first preview in the configuration preview area that is output for display is updated based on the virtual accessory being equipped on the first virtual weapon.

### RELATED APPLICATIONS

The present application is a continuation of International Application No. PCT/CN2024/118053, filed on Sep. 10, 2024, which claims priority to Chinese Patent Application No. 202311640567.0, filed on Nov. 30, 2023. The entire disclosures of the prior applications are hereby incorporated by reference.

### FIELD OF THE TECHNOLOGY

This application relates to the field of computer technologies, including a virtual accessory equipping method.

### BACKGROUND OF THE DISCLOSURE

In related competitive shooting games, there is a concept of virtual accessories. The virtual accessory may be a virtual magazine, a virtual stock, an aiming scope, or the like. Different virtual accessories bring different gains to a virtual weapon, thereby affecting game experience of a player. It can be learned from this that the virtual accessory can be extremely important in the game. How to equip the virtual accessory on the virtual weapon is a research focus in the field.

### SUMMARY

Aspects of this disclosure provide a virtual accessory equipping method, a virtual accessory equipping apparatus, and a non-transitory computer-readable storage medium. Examples of technical solutions of this disclosure may be implemented as follows:

An aspect of this disclosure provides a virtual accessory equipping method. In the method, a virtual scene including a virtual character and one or more virtual accessories is output for display. A configuration preview area with the virtual scene is output for display when the virtual character carries at least one virtual weapon. The configuration preview area includes a first preview of a first virtual weapon of the at least one virtual weapon. The first preview indicates a quantity of virtual accessories equipped on the first virtual weapon. Based on an equipping operation on a virtual accessory, the virtual accessory is equipped on the first virtual weapon carried by the virtual character. The first preview in the configuration preview area that is output for display is updated based on the virtual accessory being equipped on the first virtual weapon.

An aspect of this disclosure provides a virtual accessory equipping apparatus. The apparatus includes processing circuitry configured to output for display a virtual scene including a virtual character and one or more virtual accessories. The processing circuitry is configured to output for display a configuration preview area with the virtual scene when the virtual character carries at least one virtual weapon. The configuration preview area includes a first preview of a first virtual weapon of the at least one virtual weapon. The first preview indicates a quantity of virtual accessories equipped on the first virtual weapon. Based on an equipping operation on a virtual accessory, the processing circuitry is configured to equip the virtual accessory on the first virtual weapon carried by the virtual character. The processing circuitry is configured to update the first preview in the configuration preview area that is output for display based on the virtual accessory being equipped on the first virtual weapon.

According to an aspect, a virtual accessory equipping method is provided and performed by a computer device. The method includes: displaying a virtual scene, a virtual character and a virtual accessory existing in the virtual scene; displaying a configuration preview area in the virtual scene when the virtual character carries a virtual weapon, the virtual weapon and a first preview image being displayed in the configuration preview area, and the first preview image indicating a quantity of virtual accessories already equipped on the virtual weapon; and equipping, in response to an equipping operation for any virtual accessory in the virtual scene, the virtual accessory on a virtual weapon indicated by the equipping operation, and updating the first preview image in the configuration preview area.

According to another aspect, a virtual accessory equipping apparatus is provided. The apparatus includes: a display module, configured to display a virtual scene, a virtual character and a virtual accessory existing in the virtual scene; the display module being further configured to display a configuration preview area in the virtual scene when the virtual character carries a virtual weapon, the virtual weapon and a first preview image being displayed in the configuration preview area, and the first preview image indicating a quantity of virtual accessories already equipped on the virtual weapon; and an update module, configured to: equip, in response to an equipping operation for any virtual accessory in the virtual scene, the virtual accessory on a virtual weapon indicated by the equipping operation, and update the first preview image in the configuration preview area.

According to another aspect, a computer device is provided, the computer device including a processor and a memory, the memory being configured to store at least one segment of computer program, and the at least one segment of computer program being loaded and executed by the processor to implement the virtual accessory equipping methods in aspects of this disclosure.

An aspect of this disclosure provides a non-transitory computer-readable storage medium, having computer-executable instructions stored therein, the computer-executable instructions, when executed by a processor, cause the processor to implement the virtual accessory equipping methods in aspects of this disclosure.

According to another aspect, a computer program product is provided, including a computer program, the computer program being stored in a computer-readable storage medium, a processor of a computer device reading the computer program from the computer-readable storage medium, and the processor executing the computer program, so that the computer device performs the virtual accessory equipping methods provided in aspects of this disclosure.

An aspect of this disclosure provides a virtual accessory equipping method. When a virtual character carries a virtual weapon, a configuration preview area can be displayed in a virtual scene. The virtual weapon carried by the virtual character and a first preview image are displayed in the configuration preview area, so that a user can intuitively see an equipping status of a virtual accessory on the virtual weapon without the need of opening another interface to view the equipping status of the virtual accessory on the virtual weapon, thereby improving efficiency of human computer interaction. In addition, when the virtual accessory in the virtual scene is equipped on the virtual weapon, the first preview image displayed in the configuration preview area may be synchronously updated, to ensure real-time performance and accuracy of the first preview image. Meanwhile, the foregoing operations are completed in an interface for displaying the virtual scene, so that the user can observe, within the field of view at any time, information appearing in the virtual scene, to avoid missing information in the virtual scene due to blocking of the field of view caused by opening another interface. This improves a display effect. In this way, user experience is improved.

### BRIEF DESCRIPTION OF THE DRAWINGS

FIG. 1 is a schematic diagram of an implementation environment of a virtual accessory equipping method according to an aspect of this disclosure.

FIG. 2 is a flowchart of a virtual accessory equipping method according to an aspect of this disclosure.

FIG. 3 is a flowchart of another virtual accessory equipping method according to an aspect of this disclosure.

FIG. 4 is a schematic diagram of a virtual scene according to an aspect of this disclosure.

FIG. 5 is a schematic diagram of a configuration preview area according to an aspect of this disclosure.

FIG. 6 is a schematic diagram of a material list according to an aspect of this disclosure.

FIG. 7 is a schematic diagram of updating a configuration preview area according to an aspect of this disclosure.

FIG. 8 is a flowchart of equipping a virtual accessory on a second virtual weapon according to an aspect of this disclosure.

FIG. 9 is a schematic diagram of switching a preview image according to an aspect of this disclosure.

FIG. 10 is a flowchart of switching a preview image according to an aspect of this disclosure.

FIG. 11 is a schematic diagram of detaching a virtual accessory according to an aspect of this disclosure.

FIG. 12 is a schematic diagram of discarding a virtual accessory according to an aspect of this disclosure.

FIG. 13 is a schematic diagram of transferring a virtual accessory according to an aspect of this disclosure.

FIG. 14 is a schematic diagram of replacing a virtual accessory according to an aspect of this disclosure.

FIG. 15 is a flowchart of adjusting a virtual weapon according to an aspect of this disclosure.

FIG. 16 is a block diagram of a virtual accessory equipping apparatus according to an aspect of this disclosure.

FIG. 17 is a block diagram of a structure of a terminal according to an aspect of this disclosure.

### DETAILED DESCRIPTION

In this disclosure, the terms such as “first” and “second” are used to distinguish between same items or similar items with substantially same effects and functions. “First”, “second”, and “nth” do not have a dependency relationship in logic or time sequence, and a quantity and an execution order are not limited. The term “at least one” in this disclosure means one or more, and the term “a plurality of” in this disclosure means two or more.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In related technology, if a player expects to understand an equipping status of a virtual accessory on a virtual weapon, the player needs to first open a backpack of a virtual character to view a current equipping status of a virtual accessory on the virtual weapon. In addition, when the player expects to adjust the virtual accessory equipped on the virtual weapon, the player also needs to open the backpack of the virtual character, and equip a virtual accessory on the virtual weapon in the backpack. However, the operation of opening the backpack to view the equipping status of the virtual accessory and equip the virtual accessory is complex, affecting equipping efficiency. Based on this, an aspect of this disclosure provides a virtual accessory equipping method, so that the equipping status of the virtual accessory can be viewed or the virtual accessory can be equipped without opening the backpack of the virtual character. The following aspects describe the method in aspects of this disclosure in further detail.

For ease of understanding, terms in this disclosure are explained below. The descriptions of the terms are provided as examples only and are not intended to limit the scope of the disclosure.

Virtual scene: The virtual scene is a virtual scene displayed (or provided) when an application program is run on a terminal. The virtual scene may be a simulated environment of the real world, may be a semi-simulated and semi-fictional virtual scene, or may be a purely fictional virtual scene. The virtual scene may be a two-dimensional virtual scene, a 2.5-dimensional virtual scene, or a three-dimensional virtual scene. For example, the virtual scene may include the sky, the land, the ocean, and the like. The land may include an environment element like a desert or a city, and a user may control a virtual object to move in the virtual scene.

Virtual character: The virtual character is a movable object in a virtual world. The movable object may be at least one of a virtual character, a virtual animal, and a cartoon character. In some aspects, when the virtual world is a three-dimensional virtual world, the virtual character is a three-dimensional model. Each virtual character has a shape and a volume in the three-dimensional virtual world, and occupies a part of space in the three-dimensional virtual world. In some aspects, the virtual character is a three-dimensional character constructed based on a three-dimensional human bone technology. The virtual character realizes different external appearances by wearing different skins. In some aspects, the virtual character can be implemented by using a 2.5-dimensional model or a two-dimensional model. This is not limited in aspects of this disclosure.

Virtual accessory: The virtual accessory is usually spawned at a random position in a game map in a game, and is picked up by a player after the player approaches the virtual accessory. Each virtual weapon (for example, a virtual firearm) may be equipped with different quantities and types of virtual accessories based on features of the virtual weapon. For example, a virtual firearm A has five slots, and five virtual accessories can be installed. However, a virtual firearm B has only three slots, and only three virtual accessories can be installed. The virtual accessory may include a virtual muzzle muffler, a virtual muzzle, a virtual grip, a virtual magazine, a virtual stock, an aiming scope, and the like. The same type of virtual accessories may also include a plurality of models. The virtual muzzle muffler is used as an example. Virtual muzzle mufflers are also of firearm types, and a muffler of a virtual sniper gun cannot be equipped on another type of firearm. Equipping a virtual accessory on a virtual weapon may affect some specific values of the virtual weapon. A special virtual accessory even changes an attack mode of the virtual weapon.

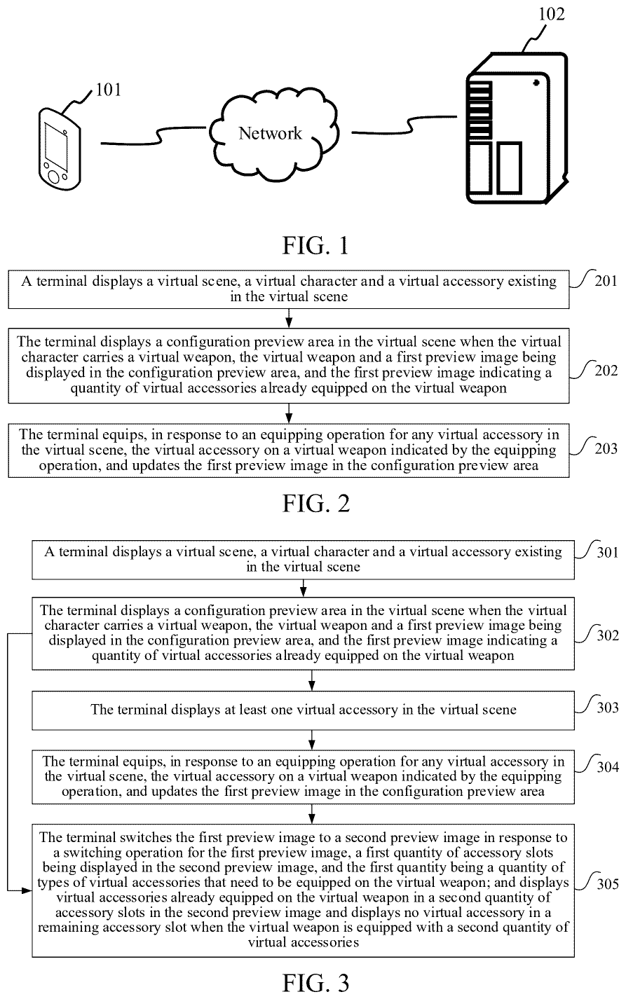

The virtual accessory equipping method according to an aspect of this disclosure can be performed by a computer device. In some aspects, the computer device is a terminal or a server. The following describes an implementation environment of the virtual accessory equipping method according to an aspect of this disclosure by using the computer device being the terminal as an example. FIG. 1 is a schematic diagram of an implementation environment of a virtual accessory equipping method according to an aspect of this disclosure. The implementation environment includes a terminal 101 and a server 102. The terminal 101 and the server 102 can be directly or indirectly connected in a wired or wireless communication manner. This is not limited in this disclosure.

In some aspects, the terminal 101 may be, but is not limited to, a smartphone, a tablet computer, a laptop computer, a desktop computer, a smart speaker, a smartwatch, an intelligent voice interaction device, an intelligent household electrical appliance, and an in-vehicle terminal. An application program supporting a virtual scene is installed and run on the terminal 101. The application program may be any one of a first-person shooting game (FPS), a third-person shooting game, a multiplayer online battle arena game (MOBA), a virtual reality application program, a three-dimensional map program, or a multiplayer online battle survival game. For example, the terminal 101 is a terminal used by a user (player). The user uses the terminal 101 to operate a virtual character in the virtual scene to perform an action. The action includes, but is not limited to, at least one of body posture adjustment, crawling, walking, running, cycling, jumping, driving, picking, shooting, attacking, and throwing. For example, the virtual character may be a virtual person like a simulated person character or an animated person character.

A person skilled in the art should understand that there may be more or fewer terminals. For example, there may be only one terminal, or there may be dozens of or hundreds of terminals or more. A quantity of terminals and a device type is not limited in aspects of this disclosure.

In some aspects, the server 102 is an independent physical server, or can be a server cluster or a distributed system formed by a plurality of physical servers, or can be a cloud server that provides basic cloud computing services such as cloud services, cloud databases, cloud computing, cloud functions, cloud storage, network services, cloud communication, middleware services, domain name services, security services, content delivery networks (CDNs), big data, and artificial intelligence platforms. The server 102 is configured to provide a backend service for an application program supporting a virtual scene. In some aspects, the server 102 is in charge of primary computing works, and the terminal 101 is in charge of secondary computing works; the server 102 is in charge of secondary computing works, and the terminal 101 is in charge of primary computing works; or the server 102 and the terminal 101 perform collaborative computing by using a distributed computing architecture.

FIG. 2 is a flowchart of a virtual accessory equipping method according to an aspect of this disclosure. This aspect of this disclosure is described by using the method being performed by a terminal as an example. The virtual accessory equipping method includes the following operations.
201: The terminal displays a virtual scene, a virtual character and a virtual accessory existing in the virtual scene. For example, a virtual scene including a virtual character and one or more virtual accessories is output for display.

In this aspect of this disclosure, the terminal displays the virtual character and a virtual material stack in the virtual scene, and the virtual material stack includes at least one virtual accessory. The virtual character is a virtual character controlled by an account currently logged into on the terminal. The virtual material stack is a material stack formed by aggregating a plurality of virtual materials. A quantity of virtual materials in the virtual material stack is not limited in aspects of this disclosure. The plurality of virtual materials in the virtual material stack may further include another virtual material in addition to the at least one virtual accessory. The virtual accessory may be a virtual muzzle, a virtual grip, a virtual magazine, a virtual stock, an aiming scope, or the like. The another virtual material may be virtual food, a virtual medicine, or the like. This is not limited in aspects of this disclosure.
202: The terminal displays a configuration preview area in the virtual scene when the virtual character carries a virtual weapon, the virtual weapon and a first preview image being displayed in the configuration preview area, and the first preview image indicating a quantity of virtual accessories already equipped on the virtual weapon. For example, a configuration preview area with the virtual scene is output for display when the virtual character carries at least one virtual weapon. The configuration preview area includes a first preview of a first virtual weapon of the at least one virtual weapon. The first preview indicates a quantity of virtual accessories equipped on the first virtual weapon.

In aspects of this disclosure, the virtual character may carry the virtual weapon. A quantity of virtual weapons is not limited in aspects of this disclosure. The virtual weapon may be a virtual firearm, a virtual crossbow, a virtual knife, or the like. This is not limited in aspects of this disclosure. For any virtual weapon, a virtual accessory may be equipped on the virtual weapon. A quantity of virtual accessories that can be equipped on the virtual weapon is not limited in aspects of this disclosure. The terminal displays the configuration preview area in the virtual scene when the virtual character carries the virtual weapon. A display position and a display pattern of the configuration preview area are not limited in aspects of this disclosure. The configuration preview area is configured for presenting an equipping status of a virtual accessory on the virtual weapon carried by the virtual character.

In some aspects, the configuration preview area includes a weapon display area and an accessory display area. The weapon display area is configured for displaying the virtual weapon carried by the virtual character. The accessory display area is configured for presenting an equipping status of a virtual accessory on each virtual weapon. The terminal displays the first preview image in the accessory display area, to intuitively display, to a user, a quantity of virtual accessories already equipped on the virtual weapon carried by the virtual character. In other words, the virtual weapon and the first preview image may be displayed in different areas.

In some aspects, the virtual character may carry a plurality of virtual weapons, the virtual weapons correspond to respective first preview images, and a first preview image of any virtual weapon indicates a quantity of virtual accessories already equipped on the virtual weapon.
203: The terminal equips, in response to an equipping operation for any virtual accessory in the virtual scene, the virtual accessory on a virtual weapon indicated by the equipping operation, and updates the first preview image in the configuration preview area. For example, based on an equipping operation on a virtual accessory, the virtual accessory is equipped on the first virtual weapon carried by the virtual character. The first preview in the configuration preview area that is output for display is updated based on the virtual accessory being equipped on the first virtual weapon.

In this aspect of this disclosure, when the equipping operation for any virtual accessory in the virtual scene is triggered, the terminal equips the virtual accessory on the virtual weapon indicated by the equipping operation. Then, the terminal updates display in the configuration preview area, in other words, updates the first preview image in the configuration preview area. The first preview image in the configuration preview area presents that a quantity of virtual accessories already equipped on the virtual weapon is increased by one, and a quantity of virtual accessories already equipped on another virtual weapon remains unchanged.

In some aspects, the terminal displays the virtual material stack in the virtual scene. When a distance between the virtual character and the virtual material stack satisfies a condition, the terminal displays a material list of the virtual material stack in the virtual scene. The material list includes at least one virtual accessory. In response to the equipping operation for any virtual accessory in the material list, the terminal equips the virtual accessory on the virtual weapon indicated by the equipping operation, and updates the first preview image in the configuration preview area.

The virtual character in aspects of this disclosure may move in the virtual scene. When the distance between the virtual character and the virtual material stack satisfies the condition, the terminal displays the material list of the virtual material stack in the virtual scene. In other words, when the virtual character approaches the virtual material stack, once the distance between the virtual character and the virtual material stack satisfies the condition, the material list of the virtual material stack is displayed in the virtual scene. The “condition” may be that the distance between the virtual character and the virtual material stack is less than a preset distance, or may be that the distance between the virtual character and the virtual material stack is in a preset distance range. This is not limited in aspects of this disclosure. The material list is configured for presenting all virtual materials on the virtual material stack, so that the user can see the at least one virtual accessory in the virtual material stack by using the material list.

An aspect of this disclosure provides a virtual accessory equipping method. When a virtual character carries a virtual weapon, a configuration preview area can be displayed in a virtual scene. The virtual weapon carried by the virtual character and a first preview image are displayed in the configuration preview area, so that a user can intuitively see an equipping status of a virtual accessory on the virtual weapon without the need of opening another interface to view the equipping status of the virtual accessory on the virtual weapon, thereby improving efficiency of human computer interaction. In addition, when the virtual accessory in the virtual scene is equipped on the virtual weapon, the first preview image displayed in the configuration preview area may be synchronously updated, to ensure real-time performance and accuracy of the first preview image. Meanwhile, the foregoing operations are completed in an interface for displaying the virtual scene, so that the user can observe, within the field of view at any time, information appearing in the virtual scene, to avoid missing information in the virtual scene due to blocking of the field of view caused by opening another interface. This improves a display effect. In this way, user experience is improved.

FIG. 3 is a flowchart of another virtual accessory equipping method according to an aspect of this disclosure. This aspect of this disclosure is described by using the method being performed by a terminal as an example. The virtual accessory equipping method includes the following operations.
301: The terminal displays a virtual scene, a virtual character and a virtual accessory existing in the virtual scene. For example, a virtual scene including a virtual character and one or more virtual accessories is output for display.

In some aspects, the terminal displays the virtual character and a virtual material stack in the virtual scene, and the virtual material stack includes at least one virtual accessory.

In this aspect of this disclosure, after a virtual battle starts, the terminal displays the virtual character and the virtual material stack in the virtual scene. The terminal can control a plurality of interaction behaviors such as activities of the virtual character in the virtual scene, picking up a virtual material in the virtual material stack, and fighting with another virtual character. An interface of the terminal that currently displays the virtual scene may be referred to as a battle interface or a primary interface, and carries primary interaction behaviors needed by the virtual character during a virtual battle. As the virtual character moves in the virtual scene, the field of view of the virtual character changes. In other words, as the virtual character moves in the virtual scene, content of the virtual scene displayed by the terminal also changes continuously. The virtual scene may include a plurality of virtual material stacks. A quantity of virtual material stacks is not limited in aspects of this disclosure. For any virtual material stack, as a distance between the virtual character and the virtual material stack gradually decreases, the virtual material stack occurs in the field of view of the virtual character. That is, the terminal displays the virtual material stack in the virtual scene.

For any virtual material stack, the virtual material stack includes a plurality of virtual materials. A quantity of virtual materials is not limited in aspects of this disclosure. The plurality of virtual materials include at least one virtual accessory and another virtual material. The virtual accessory and the another virtual material are not limited in aspects of this disclosure.

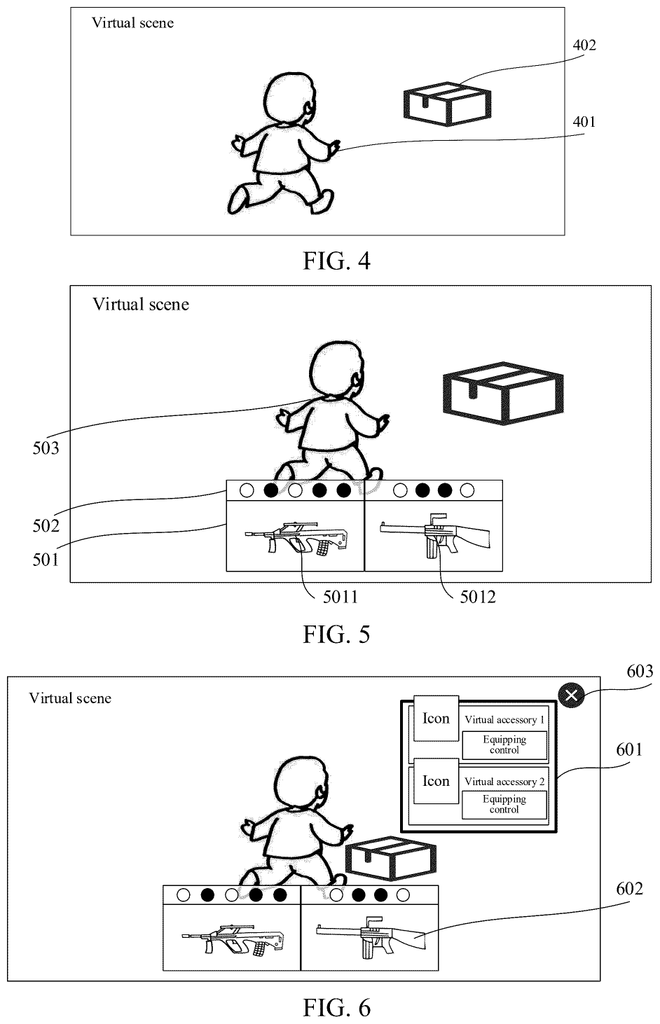

For example, FIG. 4 is a schematic diagram of a virtual scene according to an aspect of this disclosure. The terminal displays the virtual scene, and a virtual character 401 and a virtual material stack 402 exist in the virtual scene.
302: The terminal displays a configuration preview area in the virtual scene when the virtual character carries a virtual weapon, the virtual weapon and a first preview image being displayed in the configuration preview area, and the first preview image indicating a quantity of virtual accessories already equipped on the virtual weapon. For example, a configuration preview area with the virtual scene is output for display when the virtual character carries at least one virtual weapon. The configuration preview area includes a first preview of a first virtual weapon of the at least one virtual weapon. The first preview indicates a quantity of virtual accessories equipped on the first virtual weapon.

In aspects of this disclosure, the virtual character may carry the virtual weapon. The virtual weapon may be obtained through picking-up by the virtual character from the virtual scene after a virtual battle starts, or may be allocated to the virtual character before a virtual battle is performed. A manner of obtaining the virtual weapon is not limited in aspects of this disclosure. When the virtual character carries the virtual weapon, the terminal can display the configuration preview area in the virtual scene based on the virtual weapon carried by the virtual character.

In some aspects, the configuration preview area may be divided into a weapon display area and an accessory display area. The terminal displays the virtual weapon carried by the virtual character in the weapon display area, and displays the first preview image in the accessory display area, to present to a user an equipping status of a virtual accessory on the virtual weapon. A pattern of the first preview image is not limited in aspects of this disclosure.

In some aspects, an icon that can reflect the virtual accessory equipped on the virtual weapon is displayed in the first preview image. Correspondingly, a process in which the terminal displays the configuration preview area in the virtual scene includes: displaying the virtual weapon and the first preview image in the configuration preview area when the virtual character carries the virtual weapon, the first preview image including a first quantity of icons, and the first quantity being a quantity of types of virtual accessories that need to be equipped on the virtual weapon; and displaying a second quantity of icons in a first state and displaying a remaining icon in a second state in the first preview image when the virtual weapon is already equipped with a second quantity of virtual accessories.

That is, when the virtual character carries the virtual weapon, the terminal obtains the first quantity and the second quantity. The first quantity is the quantity of types of virtual accessories that need to be equipped on the virtual weapon, or the first quantity is a maximum quantity of types of virtual accessories that can be equipped on the virtual weapon. The second quantity is a quantity of types of virtual accessories already equipped on the virtual weapon. Then, the terminal displays the configuration preview area in the virtual scene based on the first quantity and the second quantity. The first preview image in the configuration preview area includes the first quantity of icons. The second quantity of icons in the first quantity of icons are presented in the first state, and a remaining icon other than the second quantity of icons is presented in the second state. The first state is configured for indicating that a virtual accessory is already equipped. The second state is configured for indicating that a virtual accessory is not equipped. In this case, the user may intuitively see a quantity of icons that are presented in the first state, to learn of a quantity of virtual accessories already equipped on the virtual weapon; and may also intuitively see a quantity of icons that are presented in the second state, to learn of a quantity of virtual accessories not equipped on the virtual weapon.

According to the solution provided in aspects of this disclosure, an equipping status of a virtual accessory on the virtual weapon is presented in a pattern of an icon, and a virtual accessory not equipped on the virtual weapon is distinguished from a virtual accessory already equipped on the virtual weapon based on icons in different states, so that a quantity of virtual accessories already equipped on the virtual weapon and a quantity of virtual accessories not equipped on the virtual weapon are more simply and intuitively fed back to the user without the need of opening another interface to view the equipping status of the virtual accessory on the virtual weapon. This improves efficiency of human computer interaction.

For example, the icon may be circular, triangular, or square. A shape of the icon is not limited in aspects of this disclosure. For example, the terminal may present the first state and the second state of icons in different shapes, different colors, different brightness, or the like of the icons. For example, an icon in the first state is presented in black, and an icon in the second state is presented in white. This is not limited in aspects of this disclosure.

In some aspects, each icon corresponds to one type of virtual accessory. In this case, when the virtual weapon is already equipped with the second quantity of virtual accessories, for any icon in the first preview image, the icon is displayed in the first state if the virtual weapon is already equipped with a virtual accessory corresponding to the icon; or the icon is displayed in the second state if the virtual weapon is not equipped with a virtual accessory corresponding to the icon.

In other words, each icon is configured for indicating a virtual accessory of a corresponding type, one icon represents one type of virtual accessory. The icon is displayed in the first state if the virtual weapon is already equipped with the type of virtual accessory corresponding to the icon; or the icon is displayed in the second state if the virtual weapon is not equipped with the type of virtual accessory corresponding to the icon. According to the solution in aspects of this disclosure, by viewing the first preview image, the user can intuitively learn of the quantity of virtual accessories equipped on the virtual weapon, and can also intuitively learn of a specific type of virtual accessory already equipped on the virtual weapon and a specific type of virtual accessory not equipped on the virtual weapon. Further, when a virtual accessory is picked up in the virtual scene, a specific type of virtual accessory to be picked up and equipped on a specific virtual weapon can be determined based on an equipping status of a virtual accessory on a current virtual weapon. The operation is simple and the user does not need to open another interface to equip the virtual accessory. This improves efficiency of equipping the virtual accessory.

For example, FIG. 5 is a schematic diagram of a configuration preview area according to an aspect of this disclosure. The terminal displays the configuration preview area at the lower part of the virtual scene. The configuration preview area includes a weapon display area 501 and an accessory display area 502. It can be learned from the weapon display area 501 that a virtual character 503 carries a first virtual weapon 5011 and a second virtual weapon 5012, and the first virtual weapon 5011 and the second virtual weapon 5012 correspond to respective first preview images. It can be learned from the accessory display area 502 that the first preview image of the first virtual weapon 5011 includes five circular icons, and the first preview image of the second virtual weapon 5012 includes four circular icons. That is, the first virtual weapon 5011 may be equipped with a maximum of five virtual accessories, and the second virtual weapon 5012 may be equipped with a maximum of four virtual accessories. Different circular icons represent different types of virtual accessories. The first virtual weapon 5011 is used as an example. The five circular icons corresponding to the first virtual weapon 5011 sequentially represent, from left to right, a virtual muzzle, a virtual grip, a virtual magazine, a virtual stock, and an aiming scope. Three of the five circular icons corresponding to the first virtual weapon 5011 present the first state (black), and two of the five circular icons present the second state (white). In other words, the first virtual weapon 5011 is already equipped with three virtual accessories: the virtual grip, the virtual stock, and the aiming scope. The first virtual weapon 5011 further lacks two virtual accessories: the virtual muzzle and the virtual magazine. The first preview image can reflect a quantity of virtual accessories already equipped on the virtual weapon and types of the equipped virtual accessories on the virtual weapon, and may be considered as a brief preview of an equipping status of an accessory.

In comparison with a backpack interface of the virtual character, a size of the configuration preview area is smaller, so that the user can observe, within the field of view at any time, information appearing in the virtual scene, to avoid missing information in the virtual scene due to blocking of the field of view caused by opening of the backpack interface. In this way, user experience is improved. The configuration preview area may alternatively be translucent, to reduce blocking on the virtual scene. Transparency of the configuration preview area is not limited in aspects of this disclosure.
303: The terminal displays at least one virtual accessory in the virtual scene. For example, a material list of a virtual material stack in the virtual scene is output for display when a distance between the virtual character and the virtual material stack satisfies a condition. The material list includes the one or more virtual accessories.

In some aspects, when the distance between the virtual character and the virtual material stack satisfies the condition, the terminal displays a material list of the virtual material stack in the virtual scene. The material list includes the at least one virtual accessory.

In aspects of this disclosure, for any virtual material stack in the virtual scene, as the virtual character approaches the virtual material stack, when a distance between the virtual character and the virtual material stack satisfies the condition, the terminal displays a material list of the virtual material stack in the virtual scene. All virtual materials in the virtual material stack are displayed in the material list. The virtual materials in the virtual material stack include the at least one virtual accessory, and the at least one virtual accessory includes a first virtual accessory. For any virtual accessory, the virtual accessory may satisfy a specification of the virtual weapon carried by the virtual character, or may not satisfy a specification of the virtual weapon carried by the virtual character. In other words, if the virtual accessory is applicable to the virtual weapon carried by the virtual character, the virtual accessory can be equipped on the virtual weapon carried by the virtual character; or if the virtual accessory is not applicable to the virtual weapon carried by the virtual character, the virtual accessory cannot be equipped on the virtual weapon carried by the virtual character. This is not limited in aspects of this disclosure.

In some aspects, the terminal displays the material list of the virtual material stack in the virtual scene based on an adaptation status of the virtual accessory and the virtual weapon. If the virtual accessory in the material list is applicable to the virtual weapon carried by the virtual character, an equipping control of the virtual accessory is displayed. In response to a trigger operation for the equipping control, the terminal picks up the virtual accessory from the virtual material stack, and equips the virtual accessory on the virtual weapon. If the virtual accessory in the material list is not applicable to the virtual weapon carried by the virtual character, an equipping control of the virtual accessory is not displayed. In response to a picking operation for the virtual accessory, the terminal picks up the virtual accessory from the virtual material stack, and places the virtual accessory in a backpack of the virtual character. According to the solution provided in aspects of this disclosure, an equipping control is displayed only for a virtual accessory that can be equipped on the virtual weapon, so that the user can intuitively see the virtual accessory that can be equipped. Therefore, using the equipping control can improve efficiency of equipping the virtual accessory.

When determining whether to display an equipping control of a virtual accessory, the terminal may detect whether specifications of the virtual accessory and the virtual weapon are consistent. If the specifications of the virtual accessory and the virtual weapon are consistent, the terminal determines that the virtual accessory is applicable to the virtual weapon, and displays the equipping control of the virtual accessory.

Alternatively, if the virtual accessory is applicable to the virtual weapon carried by the virtual character, and the virtual weapon is not currently equipped with another virtual accessory of the same type as that of the virtual accessory, an equipping control of the virtual accessory is displayed. In other words, when the specification of the virtual accessory is consistent with the specification of the virtual weapon, the terminal may detect whether the another virtual accessory of the same type as that of the virtual accessory is already equipped on the virtual weapon. If the virtual weapon is already equipped with the another virtual accessory of the same type as that of the virtual accessory, the equipping control of the virtual accessory is not displayed. That is, the virtual accessory is redundant. If the virtual weapon is not equipped with the another virtual accessory of the same type as that of the virtual accessory, the equipping control of the virtual accessory is displayed.

Alternatively, if the virtual accessory is applicable to the virtual weapon carried by the virtual character and performance of another virtual accessory that is currently equipped on the virtual weapon and that is of the same type as that of the virtual accessory is lower than performance of the virtual accessory, an equipping control of the virtual accessory is displayed. That is, when the another virtual accessory of the same type as that of the virtual accessory is already equipped on the virtual weapon, the terminal may compare the performance of the another already equipped virtual accessory with the performance of the virtual accessory. If the performance of the another already equipped virtual accessory is higher than the performance of the virtual accessory, the equipping control of the virtual accessory is not displayed. If the performance of the another already equipped virtual accessory is lower than the performance of the virtual accessory, the equipping control of the virtual accessory is displayed. In response to an equipping operation for the virtual accessory, the terminal may replace the foregoing another virtual accessory with the virtual accessory. According to the method, when a virtual accessory is picked up from the virtual material stack, if performance of the virtual accessory is better, another virtual accessory already equipped on the virtual weapon is directly replaced with the virtual accessory. The operation is simple. This can improve efficiency of equipping the virtual accessory, and also conforms to an intention of the user. In this way, user experience can be improved.

A quantity of virtual weapons carried by the virtual character is not limited in aspects of this disclosure. If the virtual character carries only one virtual weapon, when an equipping operation for a virtual accessory is triggered, the terminal equips the virtual accessory on the virtual weapon. If the virtual character carries two or more virtual weapons, when an equipping operation for a virtual accessory is triggered, the terminal equips the virtual accessory on a virtual weapon indicated by the equipping operation.

In some aspects, the virtual weapon carried by the virtual character includes a first virtual weapon and a second virtual weapon. The first virtual weapon and the second virtual weapon correspond to respective first preview images. The first virtual weapon is a virtual weapon that the virtual character is currently using, and the second virtual weapon is a virtual weapon that the virtual character is not currently using. In other words, the first virtual weapon is a virtual weapon used as the first choice when the virtual character performs interaction, and the second virtual weapon is a virtual weapon used as the second choice when the virtual character performs interaction.

The interaction may include a plurality of behaviors such as equipping a virtual accessory and battling with another virtual character. This is not limited in aspects of this disclosure. The first virtual weapon may be referred to as a primary weapon. The second virtual weapon may be referred to as a secondary weapon. A virtual accessory is equipped on the first virtual weapon by default. In aspects of this disclosure, an approach of quickly equipping a virtual accessory on the second virtual weapon is provided. Operation 303 includes the following operation 3031.
3031: The terminal displays a first virtual accessory and display an equipping control of the first virtual accessory in the virtual scene, the equipping control being configured to equip the first virtual accessory on the second virtual weapon.

For example, the material list of the virtual material stack in the virtual scene is displayed when the distance between the virtual character and the virtual material stack in the virtual scene satisfies the condition. The material list includes the first virtual accessory.

For example, the equipping control of the first virtual accessory is displayed in the virtual scene when the first virtual accessory is applicable to the second virtual weapon. The equipping control of the first virtual accessory is not displayed in the virtual scene when the first virtual accessory is not applicable to the second virtual weapon.

The terminal displays, based on an adaptation status of the first virtual accessory and the second virtual weapon, the equipping control configured to equip the first virtual accessory on the second virtual weapon. That is, the equipping control is configured to equip the first virtual accessory on the secondary weapon. According to the solution provided in aspects of this disclosure, the equipping control configured to equip the first virtual accessory on the secondary weapon is added, so that the first virtual accessory can be directly equipped on the secondary weapon by using the equipping control, and the user does not need to open another interface to equip the first virtual accessory on the secondary weapon. The operation is simple, and efficiency of equipping the virtual accessory is improved.

For example, FIG. 6 is a schematic diagram of a material list according to an aspect of this disclosure. The terminal displays the material list 601 in the virtual scene. The material list 601 includes a plurality of options of virtual materials. Due to a limitation of a size of the material list 601, FIG. 6 merely shows a trigger area of a virtual accessory 1 and a trigger area of a virtual accessory 2 in a plurality of virtual materials as an example. In response to a sliding operation for a virtual material in the material list 601, the terminal may display another virtual material in the material list 601. The virtual accessory 1 is used as an example. The trigger area of the virtual accessory 1 includes an icon and an equipping control of the virtual accessory 1. The icon of the virtual accessory 1 is configured for presenting a pattern of the virtual accessory. The equipping control of the virtual accessory 1 is configured to equip the virtual accessory 1 on a second virtual weapon 602. For example, a prompt text “equip to a secondary weapon” may be displayed on the equipping control of the virtual accessory 1.

The terminal may further display a close control 603 of the material list 601 in the virtual scene. In response to a trigger operation for the close control 603, the terminal closes display of the material list 601.
304: The terminal equips, in response to an equipping operation for any virtual accessory in the virtual scene, the virtual accessory on a virtual weapon indicated by the equipping operation, and updates the first preview image in the configuration preview area. For example, based on an equipping operation on a virtual accessory, the virtual accessory is equipped on the first virtual weapon carried by the virtual character. The first preview in the configuration preview area that is output for display is updated based on the virtual accessory being equipped on the first virtual weapon.

In aspects of this disclosure, when the virtual character carries only one virtual weapon, in response to an equipping operation for any virtual accessory, the terminal may directly equip the virtual accessory on the virtual weapon. When the terminal carries two or more virtual weapons, the terminal may determine, based on a trigger position of an equipping operation, a virtual weapon indicated by the equipping operation, to equip the virtual accessory on the virtual weapon indicated by the equipping operation.

In some aspects, as described in operation 3031, the terminal displays the first virtual accessory and the equipping control of the first virtual accessory. In this case, operation 304 includes the following operation 3041 or operation 3042.
3041: In response to a trigger operation for the equipping control, equip the first virtual accessory on the second virtual weapon, and update a first preview image of the second virtual weapon.

For the first virtual accessory, if a trigger position of the equipping operation is on the equipping control of the first virtual accessory, the terminal determines that the virtual weapon indicated by the equipping operation is the second virtual weapon (secondary weapon). Therefore, the terminal equips the first virtual accessory on the second virtual weapon, and updates the first preview image of the second virtual weapon, to prompt that a quantity of virtual accessories equipped on the second virtual weapon changes.
3042: In response to a picking operation for the first virtual accessory, equip the first virtual accessory on the first virtual weapon, and update a first preview image of the first virtual weapon.

For example, the picking operation for the first virtual accessory may be a trigger operation performed in a trigger area obtained by excluding the equipping control from a trigger area of the first virtual accessory. For the first virtual accessory, if a trigger position of the equipping operation is on a trigger area excluding the equipping control of the virtual accessory, the terminal determines that a virtual weapon indicated by the equipping operation is the first virtual weapon (primary weapon). Therefore, the terminal equips the first virtual accessory on the first virtual weapon, and updates the first preview image of the first virtual weapon, to prompt that a quantity of virtual accessories equipped on the first virtual weapon changes.

In other words, in response to a trigger operation for an equipping control of an option of any virtual accessory, the terminal equips the virtual accessory on the second virtual weapon; and in response to a trigger operation for a trigger area excluding the equipping control of an option of any virtual accessory, the terminal equips the virtual accessory on the first virtual weapon. Then, the terminal updates display in the configuration preview area based on a latest equipping status of a virtual accessory on the virtual weapon.

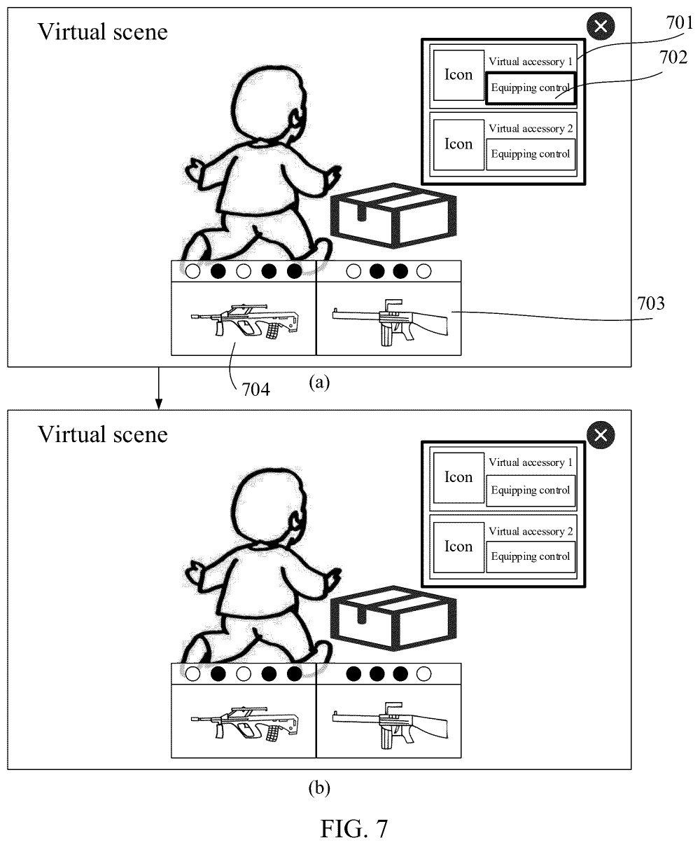

For example, FIG. 7 is a schematic diagram of updating a configuration preview area according to an aspect of this disclosure. A virtual accessory 1 is used as an example. When an equipping control 702 in a trigger area 701 of the virtual accessory 1 is triggered, the terminal equips the virtual accessory 1 on a second virtual weapon 703. For that the terminal updates a first circular icon in a first preview image of the second virtual weapon 703 in the accessory display area from the second state (white) to the first state (black), refer to (b) in FIG. 7. When a trigger area (for example, the icon of the virtual accessory 1) obtained by excluding the equipping control 702 from the trigger area 701 of the virtual accessory 1 is triggered, the terminal equips the virtual accessory 1 on a first virtual weapon 704. That the terminal updates a first circular icon in a first preview image of the first virtual weapon 704 in the accessory display area from the second state (white) to the first state (black) is the same as (b) in FIG. 7, and details are not described again.

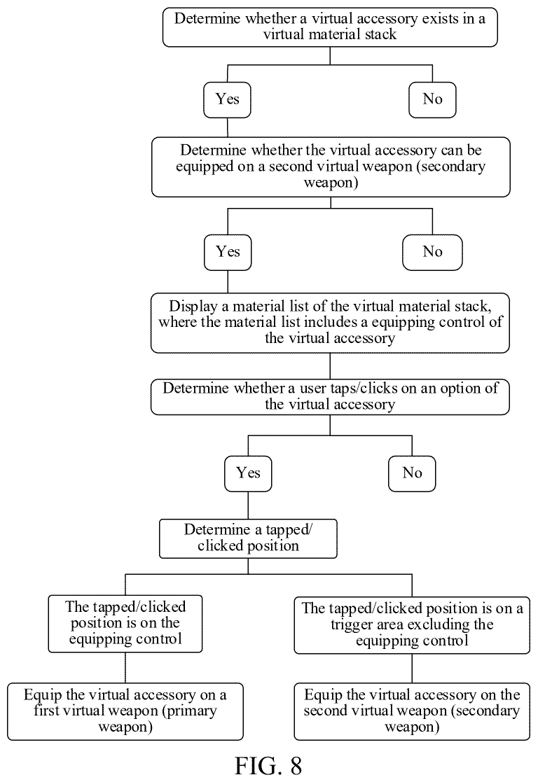

To describe a process of equipping the first virtual accessory on the second virtual weapon (secondary weapon) more clearly, the process is described below again with reference to the accompanying drawing. FIG. 8 is a flowchart of equipping a virtual accessory on a second virtual weapon according to an aspect of this disclosure. When a distance between the virtual character and any virtual material stack satisfies the condition, the terminal determines whether a virtual accessory exists in the virtual material stack. When the virtual accessory exists in the virtual material stack, the terminal determines whether the virtual accessory can be equipped on the second virtual weapon (secondary weapon). When the virtual accessory can be equipped on the second virtual weapon, the terminal displays a material list of the virtual material stack in the virtual scene. The material list includes an equipping control of the virtual accessory. Then, the terminal determines whether the user taps/clicks on a trigger area of the virtual accessory. If the trigger area of the virtual accessory is tapped/clicked on, a tapped/clicked position is determined. The terminal equips the virtual accessory on the second virtual weapon when the tapped/clicked position is on the equipping control. The terminal equips the virtual accessory on the first virtual weapon (primary weapon) when the tapped/clicked position is on a trigger area excluding the equipping control.
305: The terminal switches the first preview image to a second preview image in response to a switching operation for the first preview image, a first quantity of accessory slots being displayed in the second preview image, and the first quantity being the quantity of types of virtual accessories that need to be equipped on the virtual weapon; and displays the virtual accessories already equipped on the virtual weapon in a second quantity of accessory slots in the second preview image and displays no virtual accessory in a remaining accessory slot when the virtual weapon is already equipped with the second quantity of virtual accessories. For example, the output for display of the first preview in the configuration preview area is switched to output for display of a second preview based on a switching operation performed on the first preview. The second preview includes a plurality of accessory slots of the first virtual weapon. For each of the plurality of accessory slots, an equipped virtual accessory in the respective accessory slot is output for display when the first virtual weapon is equipped with a virtual accessory corresponding to the respective accessory slot. An empty state for the respective accessory slot is output for display when the first virtual weapon is not equipped with a virtual accessory corresponding to the respective accessory slot.

The terminal displays the first preview image in the accessory display area, and displays the second preview image in the accessory display area in response to the switching operation for the first preview image. The second preview image includes accessory slots of the virtual accessories that need to be equipped on the virtual weapon. The second quantity of accessory slots in which virtual accessories are displayed exist in the first quantity of accessory slots, and the second quantity is the quantity of types of virtual accessories already equipped on the virtual weapon. In other words, in aspects of this disclosure, in addition to viewing a quantity of the virtual accessories already equipped on the virtual weapon, the user may further intuitively see types of the virtual accessories already equipped on the virtual weapon and specific equipped virtual accessories.

For example, the switching operation may be a sliding operation such as a slide-up operation or a slide-down operation, or may be a tap/click operation such as a single-tap/click operation or a double-tap/click operation. This is not limited in aspects of this disclosure.

In some aspects, each accessory slot corresponds to one type of virtual accessory. When the virtual weapon is already equipped with the second quantity of virtual accessories, for any accessory slot in the second preview image, if the virtual weapon is already equipped with a virtual accessory corresponding to the accessory slot, the virtual accessory that corresponds to the accessory slot and that is already equipped on the virtual weapon is displayed in the accessory slot; or if the virtual weapon is not equipped with a virtual accessory corresponding to the accessory slot, no virtual accessory is displayed in the accessory slot.

Each accessory slot is configured for indicating a virtual accessory of a corresponding type, and one accessory slot represents one type of virtual accessory. If the virtual weapon is already equipped with the type of virtual accessory corresponding to the accessory slot, the type of virtual accessory already equipped on the virtual weapon is displayed in the accessory slot. If the virtual weapon is not equipped with the type of virtual accessory corresponding to the accessory slot, no virtual accessory is displayed in the accessory slot. In other words, for an already equipped virtual accessory, the terminal displays the virtual accessory in an accessory slot that corresponds to the virtual accessory and that is in the second preview image, to present, to the user, a pattern of the already equipped virtual accessory. For a virtual accessory that is not equipped, the terminal displays that an accessory slot that corresponds to the virtual accessory and that in the second preview image is empty. In this aspect of this disclosure, by viewing the second preview image, the user can intuitively learn of the quantity of virtual accessories equipped on the virtual weapon, and can also intuitively learn of specific virtual accessories already equipped on the virtual weapon and a specific type of virtual accessory not equipped on the virtual weapon. Further, when a virtual accessory is picked up in the virtual scene, a specific type of virtual accessory to be picked up and equipped on a specific virtual weapon can be determined based on an equipping status of a virtual accessory on a current virtual weapon. The operation is simple and the user does not need to open another interface to equip the virtual accessory. This improves efficiency of equipping the virtual accessory.

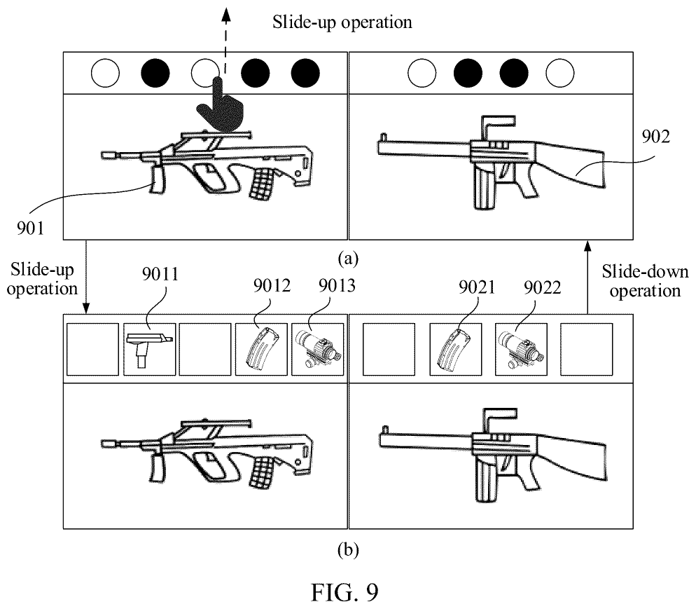

For example, FIG. 9 is a schematic diagram of switching a preview image according to an aspect of this disclosure. (a) in FIG. 9 shows a first preview image in the accessory display area as an example. In response to a slide-up operation for the first preview image, the terminal displays a second preview image in the accessory display area. (b) in FIG. 9 shows the second preview image in the accessory display area as an example. For any virtual weapon, the terminal displays, in a second preview image of the virtual weapon, an accessory slot of a virtual accessory that needs to be equipped on the virtual weapon. It can be learned from (b) in FIG. 9 that, accessory slots of five virtual accessories that need to be equipped on a first virtual weapon 901 are displayed in a second preview image of the first virtual weapon 901, and accessory slots of four virtual accessories that need to be equipped on a second virtual weapon 902 are displayed in a second preview image of the second virtual weapon 902. It can be learned from the second preview images that the first virtual weapon 901 is already equipped with virtual accessories such as a virtual grip 9011, a virtual magazine 9012, and an aiming scope 9013, and the second virtual weapon 902 is already equipped with virtual accessories such as a virtual magazine 9021 and an aiming scope 9023. A second preview image can reflect a pattern (form) of a virtual accessory already equipped on the virtual weapon, and may be considered as a detailed preview of an equipping status of an accessory. In response to a switching operation for the second preview image, the terminal displays the first preview image in the accessory display area. The switching operation may be a slide-down operation. This is not limited in aspects of this disclosure.

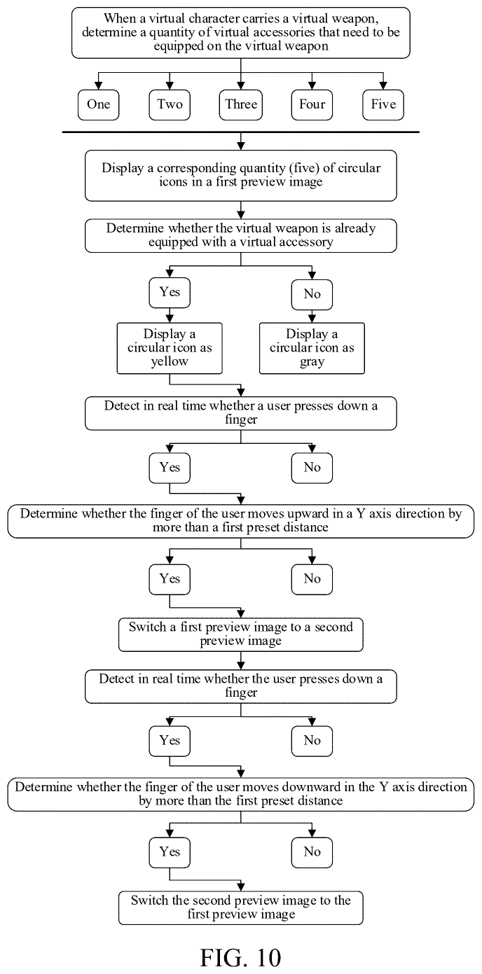

To describe the process of switching the preview image in aspects of this disclosure more clearly, the process is further described below with reference to the accompanying drawing. FIG. 10 is a flowchart of switching a preview image according to an aspect of this disclosure. When the virtual character carries the virtual weapon, the terminal determines a quantity of virtual accessories that need to be equipped on the virtual weapon. For example, the quantity of virtual accessories that need to be equipped on the virtual weapon is 5. Subsequently, the terminal can display five circular icons in the first preview image. Then, the terminal determines whether the virtual weapon is already equipped with a virtual accessory. Subsequently, the terminal can display, as yellow, a circular icon that is in the first preview image and that corresponds to an already equipped virtual accessory, and display, as gray, a circular icon that that is in the first preview image and that corresponds to a virtual accessory that is not equipped. The terminal displays the first preview image in the accessory display area based on the foregoing process. Then, the terminal detects in real time whether the user presses down a finger. When the user presses down the finger, the terminal determines whether the finger of the user moves upward in a Y axis direction (vertical direction) by more than a first preset distance. The first preset distance may be a width of five pixels. A value of the first preset distance is not limited in aspects of this disclosure. That is, the terminal determines whether the user triggers a slide-up operation for the first preview image. When the finger of the user moves upward in the Y axis direction by more than the first preset distance, the terminal switches the first preview image to the second preview image in the accessory display area. Then, the terminal detects in real time whether the user presses down a finger. When the user presses down the finger, the terminal determines whether the finger of the user moves downward in the Y axis direction by more than the first preset distance. That is, the terminal determines whether the user triggers a slide-down operation for the second preview image. When the finger of the user moves downward in the Y axis direction by more than the first preset distance, the terminal switches the second preview image in the accessory display area to the first preview image.

In the second preview image, the user may perform operations such as detaching, discarding, transferring, or replacing, on a virtual accessory on the virtual weapon, to adjust the virtual accessory on the virtual weapon without opening another interface. This improves efficiency of adjusting the virtual accessory. The following separately describes processes of detaching, discarding, transferring, and replacing the virtual accessory.

In some aspects, the virtual accessory on the virtual weapon may be detached by performing an operation in the second preview image. Correspondingly, in response to a detaching operation for any virtual accessory in the second preview image, the virtual accessory is detached from the virtual weapon, the detached virtual accessory is placed in the backpack of the virtual character, and an accessory slot that corresponds to the virtual accessory and that is in the second preview image is displayed as empty.

In other words, for any virtual accessory in the second preview image, in response to the detaching operation for the virtual accessory, the terminal displays that an accessory slot that corresponds to the virtual accessory and that is in the second preview image is empty. The detaching operation is configured for detaching the virtual accessory from the virtual weapon and placing the virtual accessory in the backpack of the virtual character. The detaching operation is not limited in aspects of this disclosure. In some aspects, the detaching operation is a tap/click operation. Correspondingly, for any virtual accessory in the second preview image, in response to a tap/click operation for the virtual accessory, the terminal detaches the virtual accessory from the virtual weapon and places the virtual accessory in the backpack of the virtual character. The terminal displays that the accessory slot that corresponds to the virtual accessory and that is in the second preview image is empty.

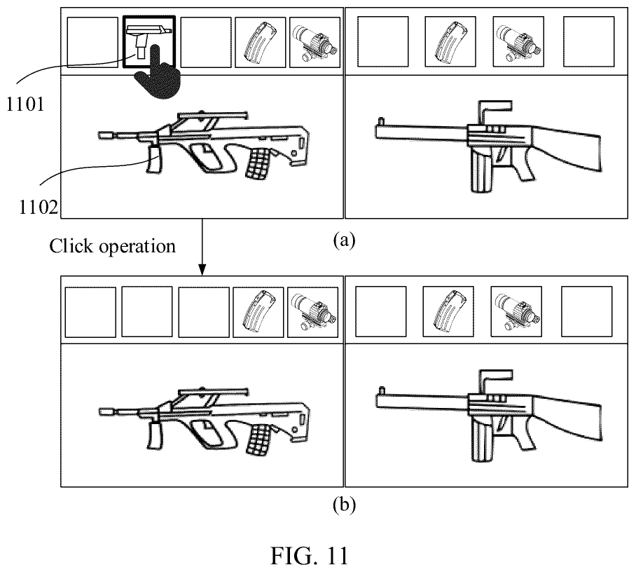

For example, FIG. 11 is a schematic diagram of detaching a virtual accessory according to an aspect of this disclosure. In response to a tap/click operation for a virtual accessory 1101, the terminal detaches the virtual accessory 1101 from a virtual weapon 1102, and places the virtual accessory 1101 in the backpack of the virtual character. The terminal displays that an accessory slot that corresponds to the virtual accessory 1101 and that is in the second preview image is empty. When a finger of the user presses down at the virtual accessory 1101, the terminal displays the accessory slot of the virtual accessory 1101 in a highlight manner, to present, to the user, that the virtual accessory to be operated is selected. For example, a color of an accessory slot of an unselected virtual accessory is different from a color of an accessory slot of a selected virtual accessory, to display the accessory slot of the selected virtual accessory in a highlight manner. Alternatively, brightness of an accessory slot of an unselected virtual accessory is different from brightness of an accessory slot of a selected virtual accessory, to display the accessory slot of the selected virtual accessory in a highlight manner. A manner of displaying in a highlight manner is not limited in aspects of this disclosure.

In some aspects, any virtual accessory already equipped on the virtual weapon may be discarded by performing an operation in the second preview image. Correspondingly, in response to a discarding operation for any virtual accessory in the second preview image, the virtual accessory is detached from the virtual weapon, the detached virtual accessory is placed in the virtual scene, and an accessory slot that corresponds to the virtual accessory and that is in the second preview image is displayed as empty.

In other words, for any virtual accessory in the second preview image, in response to the discarding operation for the virtual accessory, the terminal displays that an accessory slot that corresponds to the virtual accessory and that is in the second preview image is empty. The discarding operation is configured for detaching the virtual accessory from the virtual weapon and placing the virtual accessory in the virtual scene. Then, the terminal may display the virtual accessory in the virtual scene. The discarding operation is not limited in aspects of this disclosure. In some aspects, the discarding operation is a slide-up operation. Correspondingly, for any virtual accessory in the second preview image, in response to a slide-up operation for the virtual accessory, the terminal detaches the virtual accessory from the virtual weapon, and places the virtual accessory in the virtual scene.

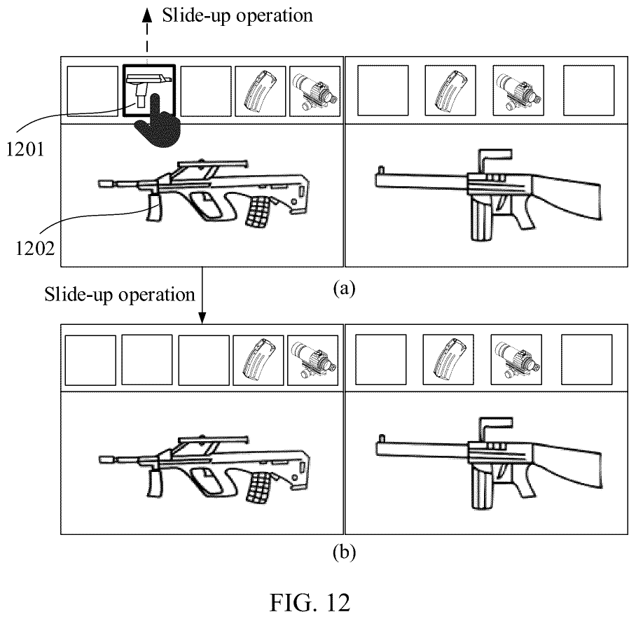

For example, FIG. 12 is a schematic diagram of discarding a virtual accessory according to an aspect of this disclosure. In response to a slide-up operation for a virtual accessory 1201, the terminal detaches the virtual accessory 1201 from a virtual weapon 1202, and places the virtual accessory 1201 in the virtual scene. The terminal displays that an accessory slot that corresponds to the virtual accessory 1201 and that is in the second preview image is empty. The terminal detects in real time whether the user presses down a finger. When the user presses down the finger, if the finger of the user presses down at the accessory slot corresponding to the virtual accessory 1201, and the finger of the user moves upward in the Y axis direction by more than a second preset distance, it is determined that the user performs a slide-up operation for the virtual accessory 1201. The second preset distance may be a width of 15 pixels. A value of the second preset distance is not limited in aspects of this disclosure. In response to the slide-up operation for the virtual accessory 1201, the terminal discards the virtual accessory 1201 in the virtual scene.

In some aspects, a virtual accessory on a specific virtual weapon may be transferred to another virtual weapon by performing an operation in the second preview image. In some aspects, the virtual weapon carried by the virtual character includes the first virtual weapon and the second virtual weapon, the first virtual weapon and the second virtual weapon correspond to respective second preview images, and a second virtual accessory is equipped on the first virtual weapon. Correspondingly, in response to an operation of transferring the second virtual accessory in the second preview image of the first virtual weapon to the second preview image of the second virtual weapon, the second virtual accessory on the first virtual weapon is transferred to the second virtual weapon, display of the second virtual accessory is canceled in the second preview image of the first virtual weapon, and the second virtual accessory is displayed in the second preview image of the second virtual weapon.

In other words, the first virtual weapon and the second virtual weapon carried by the virtual character are displayed in the weapon display area. The second preview image of the first virtual weapon and the second preview image of the second virtual weapon are displayed in the accessory display area, and the second virtual accessory already equipped on the first virtual weapon is displayed in the second preview image of the first virtual weapon. In response to a transfer operation for the second virtual accessory in the second preview image of the first virtual weapon, the terminal displays that an accessory slot that corresponds to the second virtual accessory and that is in the second preview image of the first virtual weapon is empty, and displays the second virtual accessory in an accessory slot that corresponds to the second virtual accessory and that is in the second preview image of the second virtual weapon.

For example, each accessory slot in the second preview image corresponds to one type of virtual accessory, and the second virtual accessory belongs to a target type of virtual accessory. Correspondingly, when the second virtual weapon matches with the virtual accessory of the target type and is not equipped with the virtual accessory of the target type, in response to the transfer operation for the second virtual accessory in the second preview image of the first virtual weapon, the terminal displays that an accessory slot that corresponds to the target type and that is in the second preview image of the first virtual weapon is empty, and displays the second virtual accessory in an accessory slot that corresponds to the target type and that is in the second preview image of the second virtual weapon. The transfer operation is configured for transferring a virtual accessory on one virtual weapon to another virtual weapon.

The transfer operation may be a dragging operation for a virtual accessory. This is not limited in aspects of this disclosure. For example, in response to an operation of dragging the second virtual accessory from the accessory slot that corresponds to the target type and that is in the second preview image of the first virtual weapon to the accessory slot that corresponds to the target type and that is in the second preview image of the second virtual weapon, the terminal transfers the second virtual accessory on the first virtual weapon to the second virtual weapon, and the terminal displays that the accessory slot that corresponds to the target type and that is in the second preview image of the first virtual weapon is empty, and displays the second virtual accessory in the accessory slot that corresponds to the target type and that is in the second preview image of the second virtual weapon.

In the foregoing transfer process, only an example in which the virtual accessory on the first virtual weapon is transferred to the second virtual weapon is used. In addition, a virtual accessory on the second virtual weapon may also be transferred to the first virtual weapon in the same manner. Details are not described herein again.

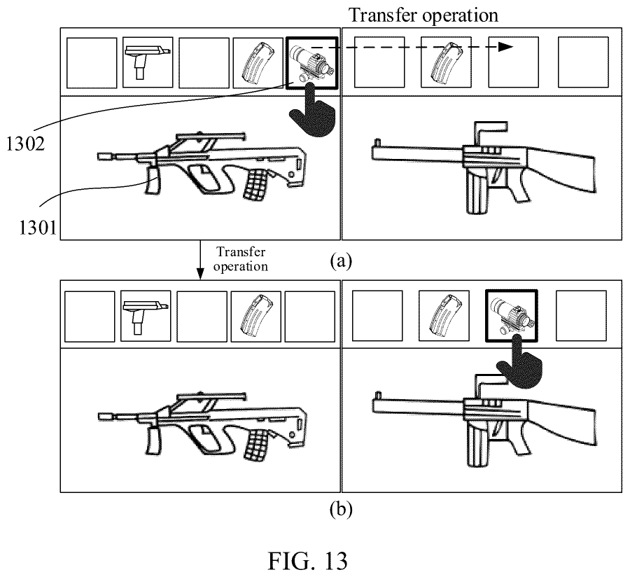

For example, FIG. 13 is a schematic diagram of transferring a virtual accessory according to an aspect of this disclosure. A first virtual weapon 1301 is equipped with an aiming scope 1302. A second virtual weapon 1303 can be equipped with an aiming scope, and is not equipped with an aiming scope. In response to a dragging operation for the aiming scope 1302, the terminal transfers the aiming scope 1302 on the first virtual weapon 1301 to the second virtual weapon 1303, displays that an accessory slot that corresponds to the aiming scope and that is in a second preview image of the first virtual weapon 1301 is empty, and displays the aiming scope 1302 in an accessory slot that corresponds to the aiming scope and that is in a second preview image of the second virtual weapon 1303.

In some aspects, the terminal exchanges virtual accessories on any two virtual weapons by using second preview images. In some aspects, the virtual weapon carried by the virtual character includes the first virtual weapon and the second virtual weapon, the first virtual weapon and the second virtual weapon correspond to respective second preview images, a third virtual accessory is equipped on the first virtual weapon, and a fourth virtual accessory is equipped on the second virtual weapon. Correspondingly, in response to an exchange operation for the third virtual accessory in the second preview image of the first virtual weapon and the fourth virtual accessory in the second preview image of the second virtual weapon, the third virtual accessory on the first virtual weapon is exchanged with the fourth virtual accessory on the second virtual weapon, the fourth virtual accessory is displayed in the second preview image of the first virtual weapon, and the third virtual accessory is displayed in the second preview image of the second virtual weapon.

In other words, the first virtual weapon and the second virtual weapon carried by the virtual character are displayed in the weapon display area. The second preview image of the first virtual weapon and the second preview image of the second virtual weapon are displayed in the accessory display area, the third virtual accessory already equipped on the first virtual weapon is displayed in the second preview image of the first virtual weapon, and the fourth virtual accessory already equipped on the second virtual weapon is displayed in the second preview image of the second virtual weapon. The third virtual accessory and the fourth virtual accessory are virtual accessories of the same type. Correspondingly, in response to the exchange operation for the third virtual accessory and the fourth virtual accessory, the terminal displays the fourth virtual accessory in the second preview image of the first virtual weapon, and displays the third virtual accessory in the second preview image of the second virtual weapon. The exchange operation is configured for exchanging virtual accessories that are of the same type and that are on two virtual weapons.

For example, each accessory slot in the second preview image corresponds to one type of virtual accessory. The third virtual accessory and the fourth virtual accessory are both virtual accessories of a target type. The third virtual accessory is displayed in an accessory slot that corresponds to the target type and that is in the second preview image of the first virtual weapon, and the fourth virtual accessory is displayed in an accessory slot that corresponds to the target type and that is in the second preview image of the second virtual weapon. In response to the exchange operation for the third virtual accessory and the fourth virtual accessory, the terminal exchanges the third virtual accessory on the first virtual weapon with the fourth virtual accessory on the second virtual weapon, displays the fourth virtual accessory in the accessory slot that corresponds to the target type and that is in the second preview image of the first virtual weapon, and displays the third virtual accessory in the accessory slot that corresponds to the target type and that is in the second preview image of the second virtual weapon.

The exchange operation may be a dragging operation for a virtual accessory. This is not limited in aspects of this disclosure. For example, the exchange operation for the third virtual accessory and the fourth virtual accessory is an operation of dragging the third virtual accessory from the accessory slot that corresponds to the target type and that is in the second preview image of the first virtual weapon to the accessory slot that corresponds to the target type and that is in the second preview image of the second virtual weapon, or an operation of dragging the fourth virtual accessory from the accessory slot that corresponds to the target type and that is in the second preview image of the second virtual weapon to the accessory slot that corresponds to the target type and that is in the second preview image of the first virtual weapon.

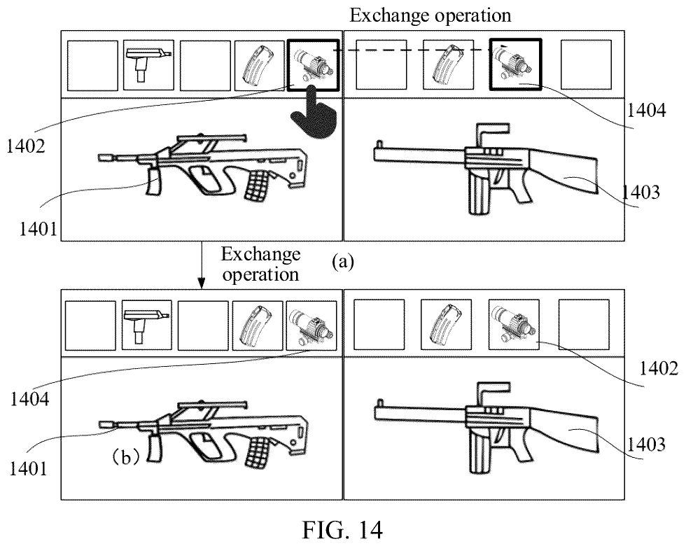

For example, FIG. 14 is a schematic diagram of replacing a virtual accessory according to an aspect of this disclosure. A first virtual weapon 1401 is equipped with a 4× scope 1402. A second virtual weapon 1403 is equipped with an 8× scope 1404. The 4× scope 1402 and the 8× scope 1404 are both aiming scopes. In response to an exchange operation for the 4× scope 1402 and the 8× scope 1404, the terminal displays the 8× scope 1404 in a second preview image of the first virtual weapon 1401, and displays the 4× scope 1402 in a second preview image of the second virtual weapon 1403. In response to a dragging operation for the 4× scope 1402, if the 4× scope 1402 is dragged to an accessory slot at which the 8× scope 1404 is located, the terminal determines that an exchange operation between the 4× scope 1402 and the 8× scope 1404 is triggered. Alternatively, in response to a dragging operation for the 8× scope 1404, if the 8× scope 1404 is dragged to an accessory slot at which the 4× scope 1402 is located, the terminal determines that an exchange operation between the 4× scope 1402 and the 8× scope 1404 is triggered.

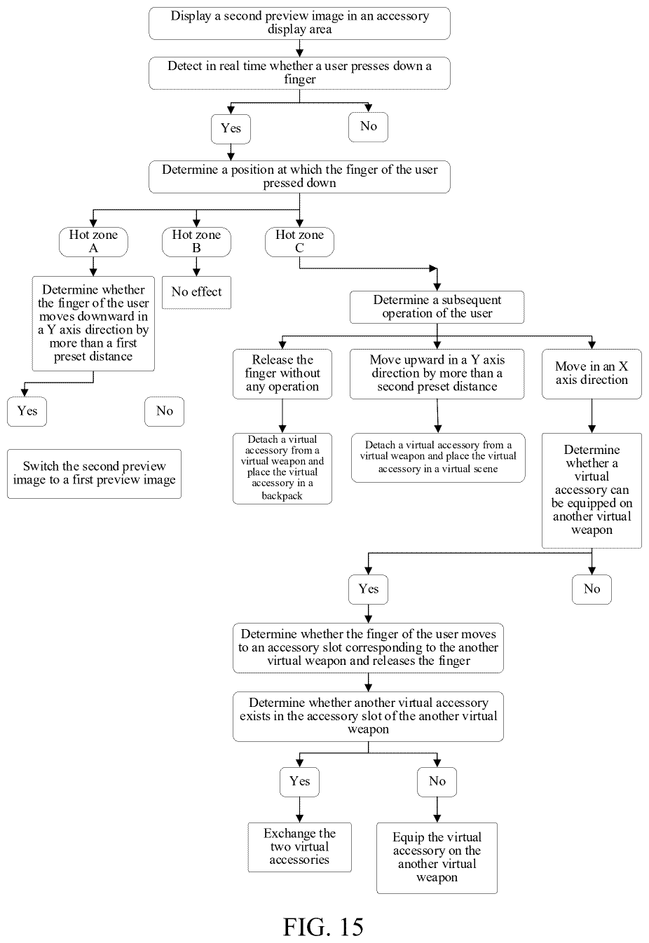

To describe the process of adjusting a virtual weapon in aspects of this disclosure more clearly, the process is further described below with reference to the accompanying drawing. FIG. 15 is a flowchart of adjusting a virtual weapon according to an aspect of this disclosure. The terminal displays the second preview image in the accessory display area. Then, the terminal detects in real time whether the user presses down a finger. When the user presses down the finger, the terminal determines a position at which the finger of the user presses down. If the finger of the user presses down at a frame (hot zone A) of an accessory slot of a virtual accessory, when the finger of the user moves downward in the Y axis direction by more than the first preset distance (for example, the width of five pixels), the terminal switches the second preview image in the accessory display area to the first preview image. If the finger of the user presses down at an empty accessory slot (hot zone B), the terminal determines that the operation of the user is invalid and does not produce any effect. If the finger of the user presses down at an accessory slot (hot zone C) in which a virtual accessory exists, the following three cases occur in a subsequent operation. In a first case, after the user releases the finger without any operation, in other words, a detaching operation for the virtual accessory is triggered, the terminal detaches the virtual accessory from the virtual weapon. In a second case, if the finger of the user moves upward in the Y axis direction by more than the second preset distance (for example, the width of 15 pixels), in other words, a discarding operation for the virtual accessory is triggered, the terminal detaches the virtual accessory from the virtual weapon, and discards the virtual accessory in the virtual scene. In a third case, if the finger of the user moves in an X axis direction (horizontal direction), the terminal determines whether the virtual accessory can be equipped on another virtual weapon. When the virtual accessory can be equipped on the another virtual weapon, the terminal determines whether the finger of the user moves to an accessory slot of the another virtual weapon and releases the finger. The terminal determines whether another virtual accessory exists in the accessory slot of the another virtual weapon. If the another virtual accessory exists, the terminal exchanges the two virtual accessories. If there is no other virtual accessory, the terminal equips the virtual accessory on the another virtual weapon.

An aspect of this disclosure provides a virtual accessory equipping method. When a virtual character carries a virtual weapon, a configuration preview area can be displayed in a virtual scene. The virtual weapon carried by the virtual character and a first preview image are displayed in the configuration preview area, so that a user can intuitively see an equipping status of a virtual accessory on the virtual weapon without the need of opening another interface to view the equipping status of the virtual accessory on the virtual weapon, thereby improving efficiency of human computer interaction. In addition, when the virtual accessory in the virtual scene is equipped on the virtual weapon, the first preview image displayed in the configuration preview area may be synchronously updated, to ensure real-time performance and accuracy of the first preview image.

Moreover, the first preview image and a second preview image displayed in the configuration preview area can reflect a quantity of virtual accessories equipped on the virtual weapon, and can also reflect types of virtual accessories equipped on the virtual weapon or specific virtual accessories equipped on the virtual weapon. In this way, the user does not need to open another interface, to learn of the specific virtual accessories already equipped on the virtual weapon. Therefore, when a virtual accessory is picked up in the virtual scene, the picked-up virtual accessory can be directly equipped on a corresponding virtual weapon based on a current equipping status of a virtual accessory on the virtual weapon. The operation is simple, and efficiency of equipping the virtual accessory is improved.

In addition, in the configuration preview area, adjustment operations such as detaching, discarding, transferring, and replacing can further be performed on the virtual accessory. Similarly, the user does not need to open another interface to adjust the virtual accessory, so that efficiency of equipping the virtual accessory is improved. A viewing requirement and an adjusting requirement of the user for the virtual accessory are unified on a primary interface, and a backpack interface does not need to be opened. Therefore, operation processes are reduced, and efficiency of human computer interaction is improved. Meanwhile, the foregoing operations are completed on the primary interface displaying the virtual scene, so that the user can observe, within the field of view at any time, information appearing in the virtual scene, to avoid missing information in the virtual scene due to blocking of the field of view caused by opening another interface. In this way, user experience is improved, and the user can focus more on a battle. In addition, the foregoing adjustment operations may be implemented by using simple interactive gestures such as tapping/clicking, dragging, and sliding up and down, without any other complex interactive operations and understandings. This reduces learning costs of the user, improves user experience, and helps the user engage better in the battle.

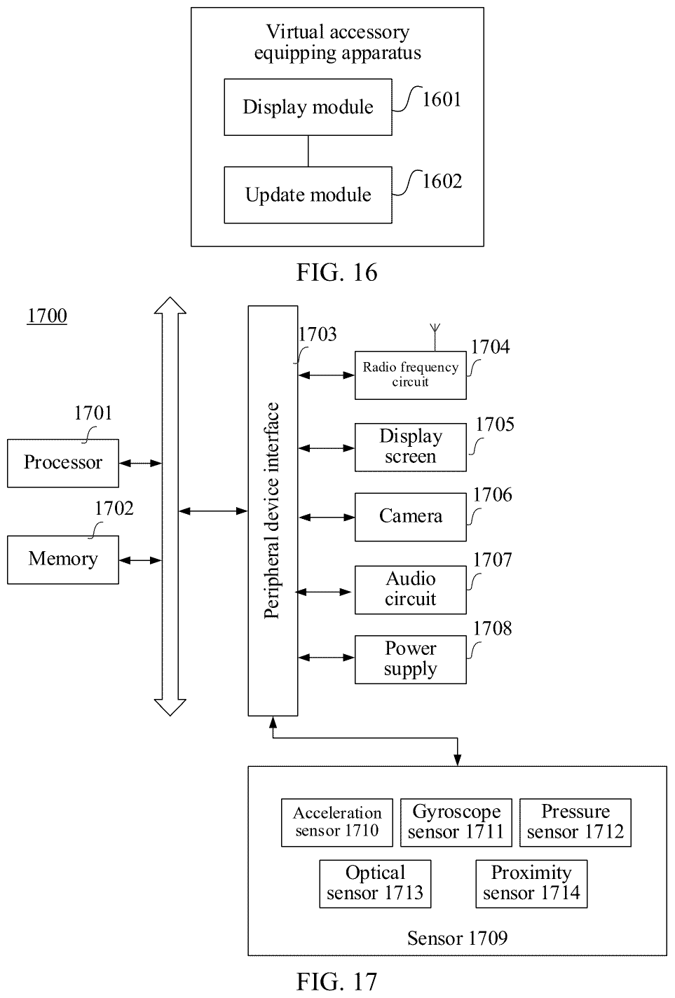

FIG. 16 is a block diagram of a virtual accessory equipping apparatus according to an aspect of this disclosure. The virtual accessory equipping apparatus is configured to perform the operations for performing the foregoing virtual accessory equipping method. The virtual accessory equipping apparatus includes a display module 1601 and an update module 1602.

The display module 1601 is configured to display a virtual scene, a virtual character and a virtual accessory existing in the virtual scene.

The display module 1601 being further configured to display a configuration preview area in the virtual scene when the virtual character carries a virtual weapon, the virtual weapon and a first preview image being displayed in the configuration preview area, and the first preview image indicating a quantity of virtual accessories already equipped on the virtual weapon.

The update module 1602 is configured to: equip, in response to an equipping operation for any virtual accessory in the virtual scene, the virtual accessory on a virtual weapon indicated by the equipping operation, and update the first preview image in the configuration preview area.

In some aspects, the display module 1601 is configured to:
display the virtual weapon and the first preview image in the configuration preview area when the virtual character carries the virtual weapon, the first preview image including a first quantity of icons, and the first quantity being a quantity of types of virtual accessories that need to be equipped on the virtual weapon; and
display a second quantity of icons in a first state and displaying a remaining icon in a second state in the first preview image when the virtual weapon is already equipped with a second quantity of virtual accessories.

In some aspects, each icon corresponds to one type of virtual accessory, and the display module 1601 is configured to:
when the virtual weapon is already equipped with the second quantity of virtual accessories, for any icon in the first preview image, display the icon in the first state if the virtual weapon is already equipped with a virtual accessory corresponding to the icon; or display the icon in the second state if the virtual weapon is not equipped with a virtual accessory corresponding to the icon.

In some aspects, the virtual weapon carried by the virtual character includes a first virtual weapon and a second virtual weapon, the first virtual weapon is a virtual weapon that the virtual character is currently using, the second virtual weapon is a virtual weapon that the virtual character is not currently using, and the first virtual weapon and the second virtual weapon correspond to respective first preview images; and the display module 1601 is configured to:
display a first virtual accessory and display an equipping control of the first virtual accessory in the virtual scene, the equipping control being configured to equip the first virtual accessory on the second virtual weapon; and
in response to a trigger operation for the equipping control, equip the first virtual accessory on the second virtual weapon, and update the first preview image of the second virtual weapon; or in response to a picking operation for the first virtual accessory, equip the first virtual accessory on the first virtual weapon, and update the first preview image of the first virtual weapon.

In some aspects, the display module 1601 is configured to display a material list of a virtual material stack in the virtual scene when a distance between the virtual character and the virtual material stack in the virtual scene satisfies a condition, the material list including the first virtual accessory.

In some aspects, the display module 1601 is configured to display the equipping control of the first virtual accessory in the virtual scene when the first virtual accessory is applicable to the second virtual weapon.

In some aspects, the display module 1601 is further configured to:
switch the first preview image to a second preview image in response to a switching operation for the first preview image, a first quantity of accessory slots being displayed in the second preview image, and the first quantity being the quantity of types of virtual accessories that need to be equipped on the virtual weapon; and
display the virtual accessories already equipped on the virtual weapon in a second quantity of accessory slots in the second preview image and display no virtual accessory in a remaining accessory slot when the virtual weapon is already equipped with the second quantity of virtual accessories.

In some aspects, each accessory slot corresponds to one type of virtual accessory, and the display module 1601 is configured to: when the virtual weapon is already equipped with the second quantity of virtual accessories, for any accessory slot in the second preview image, if the virtual weapon is already equipped with a virtual accessory corresponding to the accessory slot, display, in the accessory slot, the virtual accessory that corresponds to the accessory slot and that is already equipped on the virtual weapon; or if the virtual weapon is not equipped with a virtual accessory corresponding to the accessory slot, display no virtual accessory in the accessory slot.

In some aspects, the display module 1601 is further configured to: in response to a detaching operation for any virtual accessory in the second preview image, detach the virtual accessory from the virtual weapon, place the detached virtual accessory in a backpack of the virtual character, and display that an accessory slot that corresponds to the virtual accessory and that is in the second preview image is empty.

In some aspects, the display module 1601 is further configured to: in response to a discarding operation for any virtual accessory in the second preview image, detach the virtual accessory from the virtual weapon, place the detached virtual accessory in the virtual scene, and display that an accessory slot that corresponds to the virtual accessory and that is in the second preview image is empty.

In some aspects, the virtual weapon carried by the virtual character includes the first virtual weapon and the second virtual weapon, the first virtual weapon and the second virtual weapon correspond to respective second preview images, and a second virtual accessory is equipped on the first virtual weapon; and the display module 1601 is configured to: in response to an operation of transferring the second virtual accessory in the second preview image of the first virtual weapon to the second preview image of the second virtual weapon, transfer the second virtual accessory on the first virtual weapon to the second virtual weapon, cancel displaying the second virtual accessory in the second preview image of the first virtual weapon, and display the second virtual accessory in the second preview image of the second virtual weapon.

In some aspects, the virtual weapon carried by the virtual character includes the first virtual weapon and the second virtual weapon, the first virtual weapon and the second virtual weapon correspond to respective second preview images, a third virtual accessory is equipped on the first virtual weapon, and a fourth virtual accessory is equipped on the second virtual weapon; and the display module 1601 is configured to: in response to an exchange operation for the third virtual accessory in the second preview image of the first virtual weapon and the fourth virtual accessory in the second preview image of the second virtual weapon, exchange the third virtual accessory on the first virtual weapon with the fourth virtual accessory on the second virtual weapon, display the fourth virtual accessory in the second preview image of the first virtual weapon, and display the third virtual accessory in the second preview image of the second virtual weapon.

An aspect of this disclosure provides a virtual accessory equipping apparatus. When a virtual character carries a virtual weapon, a configuration preview area can be displayed in a virtual scene. The virtual weapon carried by the virtual character and a first preview image are displayed in the configuration preview area, so that a user can intuitively see an equipping status of a virtual accessory on the virtual weapon without the need of opening another interface to view the equipping status of the virtual accessory on the virtual weapon, thereby improving efficiency of human computer interaction. In addition, when the virtual accessory in the virtual scene is equipped on the virtual weapon, the first preview image displayed in the configuration preview area may be synchronously updated, to ensure real-time performance and accuracy of the first preview image. Meanwhile, the foregoing operations are completed in an interface for displaying the virtual scene, so that the user can observe, within the field of view at any time, information appearing in the virtual scene, to avoid missing information in the virtual scene due to blocking of the field of view caused by opening another interface. This improves a display effect. In this way, user experience is improved.

The virtual accessory equipping apparatus provided in the foregoing aspect is illustrated only with an example of division of the foregoing function modules during running of an application program. In practical applications, the foregoing functions may be allocated to and completed by different function modules based on requirements. In other words, an internal structure of the apparatus is divided into different function modules to complete all or some of the functions described above. In addition, the virtual accessory equipping apparatus and virtual accessory equipping method aspects provided in the foregoing aspects belong to the same conception. For an example of a specific implementation process, reference can be made to the method aspects. Details are not described herein again.

FIG. 17 is a block diagram of a structure of a terminal 1700 according to an aspect of this disclosure. The terminal 1700 may be a portable mobile terminal, for example, a smartphone, a tablet computer, a moving picture experts group audio layer III (MP3) player, a moving picture experts group audio layer IV (MP4) player, a notebook computer, or a desktop computer. The terminal 1700 may also be referred to as other names such as user equipment, a portable terminal, a laptop terminal, or a desktop terminal.

The terminal 1700 includes a processor 1701 (an example, of processing circuitry) and a memory 1702 (for example, a non-transitory computer-readable storage medium).

Processing circuitry, such as the processor 1701, may include one or more processing cores, such as a 4-core processor or an 8-core processor. The processor 1701 may be implemented by using at least one hardware form of a digital signal processor (DSP), a field-programmable gate array (FPGA), and a programmable logic array (PLA). The processor 1701 may alternatively include a main processor and a coprocessor. The main processor is a processor configured to process data in an awake state, and is also referred to as a central processing unit (CPU). The coprocessor is a low power consumption processor configured to process data in a standby state. In some aspects, the processor 1701 may be integrated with a graphics processing unit (GPU). The GPU is configured to render and draw content that needs to be displayed on a display screen. In some aspects, the processor 1701 may further include an artificial intelligence (AI) processor. The AI processor is configured to process computing operations related to machine learning.

The memory 1702 may include one or more computer-readable storage media. The computer-readable storage media may be non-transitory. The memory 1702 may further include a high-speed random access memory and a non-volatile memory, for example, one or more magnetic disk storage devices or flash storage devices. In some aspects, the non-transitory computer-readable storage medium in the memory 1702 is configured to store at least one computer program, and the at least one computer program is configured for being executed by the processor 1701 to implement the virtual accessory equipping method provided in the method aspects of this disclosure.

In some aspects, the terminal 1700 further includes: a peripheral device interface 1703 and at least one peripheral device. The processor 1701, the memory 1702, and the peripheral device interface 1703 may be connected through a bus or a signal wire. Each peripheral device may be connected to the peripheral device interface 1703 through a bus, a signal cable, or a circuit board. For example, the peripheral device includes at least one of a radio frequency circuit 1704, a display screen 1705, a camera 1706, an audio circuit 1707, and a power supply 1708.

In some aspects, the terminal 1700 further includes one or more sensors 1709. The one or more sensors 1709 include but are not limited to an acceleration sensor 1710, a gyroscope sensor 1711, a pressure sensor 1712, an optical sensor 1713, and a proximity sensor 1714.

A person skilled in the art may understand that the structure shown in FIG. 17 constitutes no limitation on the terminal 1700, and the terminal may include more or fewer components than those shown in the figure, or some components may be combined, or a different component deployment may be used.

An aspect of this disclosure further provides a computer-readable storage medium, such as a non-transitory computer-readable storage medium, having at least one segment of computer program stored therein, and the at least one segment of computer program being loaded and executed by a processor of a computer device to implement operations performed by the computer device in the virtual accessory equipping method in the foregoing aspects. For example, the computer-readable storage medium may be a read-only memory (ROM), a random access memory (RAM), a compact disc ROM (CD-ROM), a magnetic tape, a floppy disk, an optical data storage device, or the like.

An aspect of this disclosure further provides a computer program product, including a computer program. The computer program is stored in a computer-readable storage medium. A processor of a computer device reads the computer program from the computer-readable storage medium, and the processor executes the computer program, so that the computer device performs the virtual accessory equipping method provided in the foregoing various implementations.

An aspect of this disclosure further provides a virtual accessory equipping method. The method includes: displaying a virtual scene, a virtual character and a virtual material stack existing in the virtual scene, and the virtual material stack including at least one virtual accessory; displaying a configuration preview area in the virtual scene when the virtual character carries a virtual weapon, the configuration preview area including a weapon display area and an accessory display area, the virtual weapon being displayed in the weapon display area, a first preview image being displayed in the accessory display area, and the first preview image indicating a quantity of virtual accessories already equipped on the virtual weapon; displaying a material list of the virtual material stack in the virtual scene when a distance between the virtual character and the virtual material stack satisfies a condition, the material list including the at least one virtual accessory; and updating display in the configuration preview area in response to an equipping operation for any virtual accessory based on a virtual weapon and the virtual accessory that are indicated by the equipping operation.

In some aspects, the displaying a configuration preview area in the virtual scene when the virtual character carries a virtual weapon includes: obtaining a first quantity and a second quantity when the virtual character carries the virtual weapon, the first quantity being a quantity of types of virtual accessories that need to be equipped on the virtual weapon, and the second quantity being a quantity of types of virtual accessories already equipped on the virtual weapon; and displaying the configuration preview area in the virtual scene based on the first quantity and the second quantity, the first preview image in the configuration preview area including a first quantity of icons, each icon indicating a virtual accessory of a corresponding type, a second quantity of icons in the first quantity of icons presenting a first state, and an icon other than the second quantity of icons presenting a second state.

In some aspects, the virtual weapon carried by the virtual character includes a first virtual weapon and a second virtual weapon, the first virtual weapon is a virtual weapon used as the first choice when the virtual character performs interaction, and the second virtual weapon is a virtual weapon used as the second choice when the virtual character performs interaction. The displaying a material list of the virtual material stack in the virtual scene when a distance between the virtual character and the virtual material stack satisfies a condition includes: displaying the material list in the virtual scene when the distance between the virtual character and the virtual material stack satisfies the condition if a target virtual accessory exists in the virtual material stack, the material list including an equipping control of the target virtual accessory, and the target virtual accessory being a virtual accessory that can be equipped on the second virtual weapon, and the equipping control of the target virtual accessory is configured to equip the target virtual accessory on the second virtual weapon.

In some aspects, the method further includes: displaying a second preview image in the accessory display area in response to a switching operation for the first preview image, a first quantity of accessory slots being displayed in the second preview image, each accessory slot being configured for displaying an already equipped virtual accessory of a corresponding type, the first quantity being the quantity of types of virtual accessories that need to be equipped on the virtual weapon, a second quantity of accessory slots in which corresponding virtual accessories are displayed existing in the first quantity of accessory slots, and the second quantity being the quantity of types of virtual accessories already equipped on the virtual weapon.

In some aspects, the method further includes: for any virtual accessory in the second preview image, in response to a detaching operation for the virtual accessory, displaying that an accessory slot that corresponds to the virtual accessory and that is in the second preview image is empty, the detaching operation being configured for detaching the virtual accessory from the virtual weapon and placing the virtual accessory in a backpack of the virtual character.

In some aspects, the method further includes: for any virtual accessory in the second preview image, in response to a discarding operation for the virtual accessory, displaying that an accessory slot that corresponds to the virtual accessory and that is in the second preview image is empty, the discarding operation being configured for detaching the virtual accessory from the virtual weapon and placing the virtual accessory in the virtual scene; and
displaying the virtual accessory in the virtual scene. In some aspects, the first virtual weapon and the second virtual weapon carried by the virtual character are displayed in the configuration preview area, a first virtual accessory already equipped on the first virtual weapon is displayed in the accessory display area, and the first virtual accessory is a virtual accessory of a target type; and the method further includes:
when the second virtual weapon can be equipped with the virtual accessory of the target type and is not equipped with the virtual accessory of the target type, in response to a transfer operation for the first virtual accessory in the second preview image, in the second preview image, displaying that an accessory slot that corresponds to the target type and that is in a plurality of accessory slots corresponding to the first virtual weapon is empty, and displaying the first virtual accessory in the accessory slot that corresponds to the target type and that is in a plurality of accessory slots corresponding to the second virtual weapon, the transfer operation being configured for transferring a virtual accessory on one virtual weapon to another virtual weapon.

In some aspects, the first virtual weapon and the second virtual weapon carried by the virtual character are displayed in the configuration preview area, the first virtual accessory already equipped on the first virtual weapon and a second virtual accessory already equipped on the second virtual weapon are displayed in the accessory display area, and the first virtual accessory and the second virtual accessory are virtual accessories of the same type; and the method further includes: in response to an exchange operation for the first virtual accessory and the second virtual accessory in the second preview image, displaying the second virtual accessory in an accessory slot corresponding to the first virtual weapon, and displaying the first virtual accessory in an accessory slot corresponding to the second virtual weapon, the exchange operation being configured for exchanging virtual accessories that are of the same type and that are on two virtual weapons.

It is noted that all or some of the operations of the foregoing aspects may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely some aspects of this disclosure, and are not intended to limit this disclosure. Any modification, equivalent replacement, or improvement made within the spirit and principle of this disclosure shall fall within the scope of this disclosure.

What is claimed is:

1. A virtual accessory equipping method, comprising:
outputting for display a virtual scene including a virtual character and one or more virtual accessories;
outputting for display, by processing circuitry, a configuration preview area with the virtual scene when the virtual character carries at least one virtual weapon, the configuration preview area including a first preview of a first virtual weapon of the at least one virtual weapon, the first preview indicating a quantity of virtual accessories equipped on the first virtual weapon;
based on an equipping operation on a virtual accessory, equipping the virtual accessory on the first virtual weapon carried by the virtual character; and
updating, by the processing circuitry, the first preview in the configuration preview area that is output for display based on the virtual accessory being equipped on the first virtual weapon.

2. The method according to claim 1, wherein
the first preview includes a plurality of icons corresponding to the first virtual weapon, a number of the plurality of icons corresponding to a total number of virtual accessories allowed to be equipped on the first virtual weapon; and
a first subset of the plurality of icons is displayed in a first state and a second subset of the plurality of icons is displayed in a second state in the first preview, a number of the first subset of the plurality of icons corresponding to a number of virtual accessories currently equipped on the first virtual weapon.

3. The method according to claim 2, wherein
each of the plurality of icons corresponds to a type of virtual accessory, and
for each of the plurality of icons in the first preview,
outputting for display the respective icon in the first state when the first virtual weapon is currently equipped with the virtual accessory corresponding to the respective icon, and
outputting for display the respective icon in the second state when the first virtual weapon is not currently equipped with the virtual accessory corresponding to the respective icon.

4. The method according to claim 1, wherein
the at least one virtual weapon carried by the virtual character includes the first virtual weapon and a second virtual weapon;
the first virtual weapon being equipped by the virtual character;
the second virtual weapon not being equipped by the virtual character; and
the first preview includes a first preview image of the first virtual weapon and a second preview image of the second virtual weapon.

5. The method according to claim 4, further comprising:
outputting for display a first virtual accessory and an equip control element of the first virtual accessory, the equip control element being configured to cause the first virtual accessory to be equipped on the second virtual weapon; and
based on a trigger operation performed on the equip control element,
equipping the first virtual accessory on the second virtual weapon; and
updating the second preview image of the second virtual weapon that is output for display.

6. The method according to claim 1, further comprising:
outputting for display a material list of a virtual material stack in the virtual scene when a distance between the virtual character and the virtual material stack satisfies a condition, the material list including the one or more virtual accessories.

7. The method according to claim 5, wherein the outputting for display the equip control element comprises:
outputting for display the equip control element of the first virtual accessory when the first virtual accessory is configured to be equipped to the second virtual weapon.

8. The method according to claim 1, further comprising:
switching the output for display of the first preview in the configuration preview area to output for display of a second preview based on a switching operation performed on the first preview, the second preview including a plurality of accessory slots of the first virtual weapon; and
for each of the plurality of accessory slots,
outputting for display an equipped virtual accessory in the respective accessory slot when the first virtual weapon is equipped with a virtual accessory corresponding to the respective accessory slot, and
outputting for display an empty state for the respective accessory slot when the first virtual weapon is not equipped with a virtual accessory corresponding to the respective accessory slot.

9. The method according to claim 8, wherein each of the plurality of accessory slots corresponds to a type of the virtual accessory, and the method further comprises:
for each of the plurality of accessory slots in the second preview,
outputting for display the virtual accessory in the respective accessory slot when the first virtual weapon is equipped with the virtual accessory corresponding to the respective accessory slot, and
outputting for display an empty state for the respective accessory slot when the first virtual weapon is not equipped with the virtual accessory corresponding to the respective accessory slot.

10. The method according to claim 8, wherein the second preview includes at least one virtual accessory that is equipped on the first virtual weapon, the method further comprising:
based on a removal operation performed on a virtual accessory of the at least one virtual accessory in the second preview,
removing the virtual accessory from the first virtual weapon carried by the virtual character, and
outputting for display an empty state for the accessory slot corresponding to the virtual accessory.

11. The method according to claim 8, wherein the second preview includes at least one virtual accessory that is equipped on the first virtual weapon, the method further comprising:
based on a drop operation performed on a virtual accessory of the at least one virtual accessory in the second preview,
removing the virtual accessory from the first virtual weapon carried by the virtual character,
removing the removed virtual accessory from a virtual accessory inventory of the virtual character, and
outputting for display an empty state for the accessory slot corresponding to the virtual accessory.

12. The method according to claim 8, wherein
the at least one virtual weapon carried by the virtual character includes the first virtual weapon and a second virtual weapon;
the first virtual weapon being equipped by the virtual character;
the second virtual weapon not being equipped by the virtual character;
the second preview includes a third preview image of the first virtual weapon and a fourth preview image of the second virtual weapon; and
the method further comprises:
based on a transfer operation performed on a second virtual accessory equipped on the first virtual weapon from the third preview image of the first virtual weapon to the fourth preview image of the second virtual weapon,
transferring the second virtual accessory from the first virtual weapon to the second virtual weapon,
outputting for display an empty state for the accessory slot of the first virtual weapon corresponding to the second virtual accessory, and
outputting for display the second virtual accessory in the corresponding accessory slot of the second virtual weapon in the fourth preview image.

13. The method according to claim 12, wherein
the first virtual weapon is equipped with a third virtual accessory;
the second virtual weapon is equipped with a fourth virtual accessory of a same type as the third virtual accessory, and
the method further comprises:
based on a swapping operation performed on the third virtual accessory in the third preview image of the first virtual weapon and the fourth virtual accessory in the fourth preview image of the second virtual weapon, exchanging the third virtual accessory on the first virtual weapon with the fourth virtual accessory on the second virtual weapon,
outputting for display the fourth virtual accessory in the third preview image of the first virtual weapon, and
outputting for display the third virtual accessory in the fourth preview image of the second virtual weapon.

14. A virtual accessory equipping apparatus, comprising:
processing circuitry configured to
output for display a virtual scene including a virtual character and one or more virtual accessories;
output for display a configuration preview area with the virtual scene when the virtual character carries at least one virtual weapon, the configuration preview area including a first preview of a first virtual weapon of the at least one virtual weapon, the first preview indicating a quantity of virtual accessories equipped on the first virtual weapon;
based on an equipping operation on a virtual accessory, equip the virtual accessory on the first virtual weapon carried by the virtual character; and
update the first preview in the configuration preview area that is output for display based on the virtual accessory being equipped on the first virtual weapon.

15. The apparatus according to claim 14, wherein
the first preview includes a plurality of icons corresponding to the first virtual weapon, a number of the plurality of icons corresponding to a total number of virtual accessories allowed to be equipped on the first virtual weapon; and
a first subset of the plurality of icons is displayed in a first state and a second subset of the plurality of icons is displayed in a second state in the first preview, a number of the first subset of the plurality of icons corresponding to a number of virtual accessories currently equipped on the first virtual weapon.

16. The apparatus according to claim 15, wherein
each of the plurality of icons corresponds to a type of virtual accessory, and
the processing circuitry is configured to, for each of the plurality of icons in the first preview,
output for display the respective icon in the first state when the first virtual weapon is currently equipped with the virtual accessory corresponding to the respective icon, and
output for display the respective icon in the second state when the first virtual weapon is not currently equipped with the virtual accessory corresponding to the respective icon.

17. The apparatus according to claim 14, wherein
the at least one virtual weapon carried by the virtual character includes the first virtual weapon and a second virtual weapon;
the first virtual weapon being equipped by the virtual character;
the second virtual weapon not being equipped by the virtual character; and
the first preview includes a first preview image of the first virtual weapon and a second preview image of the second virtual weapon.

18. The apparatus according to claim 17, wherein the processing circuitry is configured to:
output for display a first virtual accessory and an equip control element of the first virtual accessory, the equip control element being configured to cause the first virtual accessory to be equipped on the second virtual weapon; and
based on a trigger operation performed on the equip control element,
equip the first virtual accessory on the second virtual weapon; and
update the second preview image of the second virtual weapon that is output for display.

19. The apparatus according to claim 14, wherein the processing circuitry is configured to:
output for display a material list of a virtual material stack in the virtual scene when a distance between the virtual character and the virtual material stack satisfies a condition, the material list including the one or more virtual accessories.

20. A non-transitory computer-readable storage medium storing instructions which, when executed by a processor, cause the processor to perform:
outputting for display a virtual scene including a virtual character and one or more virtual accessories;
outputting for display a configuration preview area with the virtual scene when the virtual character carries at least one virtual weapon, the configuration preview area including a first preview of a first virtual weapon of the at least one virtual weapon, the first preview indicating a quantity of virtual accessories equipped on the first virtual weapon;
based on an equipping operation on a virtual accessory, equipping the virtual accessory on the first virtual weapon carried by the virtual character; and
updating the first preview in the configuration preview area that is output for display based on the virtual accessory being equipped on the first virtual weapon.
